(19) United States
(12) Patent Application Publication
(10) Pub. No.: US 2025/0159275 A1
(43) Pub. Date: May 15, 2025

(54) METHODS OF EXTENDING FLATSCREEN DISPLAYS WITH XR DEVICES

(71) Applicant: Adeia Guides Inc., San Jose, CA (US)

(72) Inventors: Christopher Phillips, Hartwell, GA (US); Dhananjay Lal, Englewood, CO (US); Tao Chen, Palo Alto, CA (US)

(21) Appl. No.: 18/505,937

(22) Filed: Nov. 9, 2023

(51) Int. Cl. H04N 21/43; H04N 19/17; H04N 21/234; H04N 21/239; H04N 21/414; H04N 21/81

(52) U.S. Cl. CPC H04N 21/43079; H04N 19/17; H04N 21/23412; H04N 21/23418; H04N 21/23424; H04N 21/2393; H04N 21/41407; H04N 21/8133

(57) ABSTRACT

Systems and methods for extending the span of content displayed in a first view frustum by virtually overlaying a virtual portion of the content on a display of an XR device are described. A composite image, which includes a primary image portion, and an enhanced image portion are requested. The primary image portion is to be displayed on a physical display having a first view frustum. Characteristics of the enhanced image portion are determined based on factors such as the user comfort, field of view from the XR device, and system rendering and encoding capabilities. The primary image portion is displayed in a first view frustum simultaneously and synchronized with the enhanced image portion in a second view frustum. The enhanced image portion is anchored, and color matched with the primary image portion to provide the appearance of one single composite display that has image and color continuity.

### TECHNICAL FIELD

Embodiments of the present disclosure relate to extending the span of content on a physical display by providing a composite image that includes displaying a portion of the content on a physical display and the remaining portion of the content virtually on a virtual display while maintaining continuity of image and color between the portions displayed on the physical display and the virtual display. Some embodiments or aspects may relate to other features, functionalities, or fields.

### BACKGROUND

In the early years of the television, the size of the display screen of the TV used to be 4 to 6 inches measured diagonally. Over the course of 100 years, as display technology advanced, manufacturers offered TVs with larger displays year over year. Since the 1990s alone, TV display screens size doubled from an average of 23 inches to 47 inches. More recent version of TVs includes much larger display screen sizes in the range of 65 to 85 inches long diagonally.

Similarly, display screens for other display devices, such as desktops, laptop computers, and tablets also grew larger over time. In addition to display size, the quality of image on the TVs was also enhanced over the years with latest TVs providing 4K, 8K, organic light emitting diode (OLED) display, quantum light emitting diode (QLED) type high end resolution.

Although several advances to size and image quality of the display screen have been made, there are still some problems with existing display solutions. One such problem relates to the size of the TV itself. In some scenarios, even a big TV (or display) may not be big enough to provide the display space desired by consumers, especially since content has become more immersive, such as gaming content played using the TV as a display device. While the user may be able to purchase a larger TV to view the same content, the cost of a larger TV can be exorbitant. Moreover, even if a user can easily obtain a large TV, the content itself may not provide a perspective that is sufficiently wide or large for the user. For example, in a soccer or football match, the perspective of the displayed content may often reveal only a portion of the field where the ball is currently located, and the user may miss out on seeing the entire field. That is, even putting aside the cost of obtaining a larger TV, a larger TV displaying the same content does not provide the user with a wider perspective of the same underlying content. The consumer will not see any more of the playing field than he would have with a smaller TV.

In some instances, a consumer may watch content on a virtual reality (VR) headset. When a user wears a virtual reality headset, it wraps around her head, or some portion of her head and is all encompassing over the eyes of the user. Unfortunately, VR approaches often isolate users from people in the same physical environment (e.g., people that may wish to watch the content with the user). Using the example of the football or soccer game above, while each user may watch the game in VR, this socially isolates the users from one another, diminishing the group experience and the group dynamic. Likewise, in a social scenario, it is possible that one user may want a larger field of view than the others watching the display, such as in a gaming scenario where having larger peripheral vision may translate to better performance, such as in a first-person shooter game. Further still, a virtual reality headset often cuts off the user from rest of the world, potentially creating safety hazards. For example, while watching the football game in their virtual reality headset, if the user wants to grab a beverage, it may be unsafe for the user to walk around with the headset (e.g., due to the immersive VR experience provided by the VR headset, it may be difficult or impossible to see much, if any, of his or her physical environment). Further, VR headsets can be inconvenient. For example, if the user decides to take off the headset to eat, this necessitates taking time away from watching the game. Moreover, like the larger TV, a VR headset displaying the same content will not increase perspective of the underlying content. That is, a user may utilize a large virtual screen in VR to watch a game, but the user will see the game from the same perspective as he would if he were watching the game on his TV. Without adding to or changing the underlying content, the user will not see any more of the field than he would watching the game on his TV, for example.

Yet another problem with solutions implemented entirely within VR is that it cuts the user off from rest of the world potentially creating safety hazards. For example, while watching the football game in their virtual reality headset, if the user desires to grab a beverage, it may be unsafe for the user to walk around with the headset all-encompassing their eyes. If the user decides to take off the headset, that may take time away from watching the game.

Further still, in some approaches, extended reality (XR) headsets, which include virtual and augmented reality headsets, may be utilized. For example, XR objects may be presented to provide a user with ancillary statistics or atmospheric graphics (e.g., ambient lighting, textures, etc.). Additionally, some XR devices such as Apple Vision Pro™ and Meta Quest 3™ aim to provide mixed reality or extended reality, where users can continue to view their surroundings in the mixed reality mode, while augmenting the reality with virtual objects. While these AR approaches may allow the user to see some of her surroundings and thereby mitigate some of the safety problems associated with virtual reality headsets, providing simple AR objects with ancillary statistics or atmospheric graphics does little to address a user's desire to view a given content item from a wider or broader perspective.

As such, there is a need for a display solution that solves some of the problems described above.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process of providing a composite image that extends the span of a primary image displayed on the display of a physical display device (PDD), in accordance with some embodiments of the disclosure;

FIG. 2 is a block diagram of an example system for providing a composite image that extends the span of a primary image displayed on the display of a PDD, in accordance with some embodiments of the disclosure;

FIG. 3 is a block diagram of an XR device used for displaying the composite image, in accordance with some embodiments of the disclosure;

FIG. 4 is a flowchart of a process for providing a composite image that includes primary and enhanced image portions of the composite image, in accordance with some embodiments of the disclosure;

FIG. 5 is a flowchart of communications between a server, a PDD and an XR device for transmitting and displaying a composite image, in accordance with some embodiments of the disclosure;

FIG. 5B is a flow of a stream carrying different portions of a composite display, in accordance with some embodiments of the disclosure;

FIG. 6A is an example of a living room that includes a PDD, in accordance with some embodiments of the disclosure;

FIG. 6B is an example of different portions of a composite image, in accordance with some embodiments of the disclosure;

FIG. 7 is an example of pixel stream length determined based on size of virtual extension (enhanced image portion) that provides a larger span of content, in accordance with some embodiments of the disclosure;

FIG. 8 is a flowchart of a process for determining extent of the span of the enhanced image portion based on various factors, in accordance with some embodiments of the disclosure;

FIG. 9 is a flowchart of a process for calibrating the enhanced image portion of the composite image with the primary image portion of the composite image, in accordance with some embodiments of the disclosure;

FIG. 10 is an example of rendering and calibrating the enhanced image portion with the primary image portion, in accordance with some embodiments of the disclosure;

FIG. 11 is an example of a side-by-side comparison of a primary image portion, an enhanced image portion, and the two together as composite image, and the calibration of the enhanced image portion with the primary image portion, in accordance with some embodiments of the disclosure;

FIG. 12 is a flowchart of a process of color-matching the enhanced image portion of the composite image with the primary image portion of the composite image, in accordance with some embodiments of the disclosure;

FIG. 13 is an example of a cloud rendered system architecture for providing a composite image, in accordance with some embodiments of the disclosure;

FIG. 14 is an example of a process for rendering on a client side (PDD or XR display) for providing a composite image, in accordance with some embodiments of the disclosure; and

FIG. 15 is an example of a local rendered system architecture for providing a composite image, in accordance with some embodiments of the disclosure.

### DETAILED DESCRIPTION

In accordance with some embodiments disclosed herein, some of the above-mentioned limitations are overcome by providing a composite image of a content item via an XR device that includes a primary image portion displayed on a display associated with a physical display device, such as a TV, and an enhanced image portion, which is a virtual portion, displayed at the XR device where the enhanced image portion of the composite image virtually extends the span of the content item beyond the display associated with the physical display device. The display of the XR device may be a projector of the XR device. In such instances, displaying an image or virtual object at the XR device includes projecting the image or virtual object directly onto a surface of the eye of the user (e.g., using lasers) This technique may be referred to as retinal projection. In some instances, a projector of the XR device projects an image or virtual object onto a surface near the eye (e.g., a semi-transparent or transparent surface such as glass). Displaying the image or virtual object may include displaying the image or virtual object at one or more near-eye screens or displays of the XR device.

In some embodiments, the process of providing the composite image includes identifying a content item, such as a media asset, video file, image, etc., that is to be displayed on a display associated with a physical display device (PDD). The PDD may be a TV, laptop, tablet, or some other processing device. The display that is associated with the PDD, may be a screen or display of the TV, a display of a projector, a screen of a computer monitor, a screen of a laptop, etc. Although references are made to PDD for processing a stream, where the processing unit is integrated in the PDD, such as a smart TV, the embodiments are not so limited and the processing may also be performed by other devices, such as a set-top-box (STB), streaming stick, console, etc., that may be communicatively coupled to the physical display.

When content is displayed on a display of the PDD, the displayed content has a viewing frustum at any given time. This viewing frustum is the region of space in a scene or modeled world for a particular frame or image of a particular content item. The viewing frustum of the PDD at a given time for a given frame in a given content item may be referred to herein as a first viewing frustum. Note, the first viewing frustum, as used herein, is a property of the image or scene (or the modeled world), not a property of the display itself. A viewing frustum may be thought of as a field of view for a camera or perspective from which the content is displayed. With movies or shows, the viewing frustum of a frame is often fixed. With video games, the viewing frustum may be adjustable. For example, some games allow players to modify the “virtual camera” from which the depicted scene is shown. For example, in some instances, players may change the position or orientation of the virtual camera or may zoom the “captured” scene in or out, thereby adjusting the field of view or frustum of the in-game world depicted on the player's display. In some instances, the viewing frustum for a given display, frame, or image of a content item may be referred to as a “content field of view.”

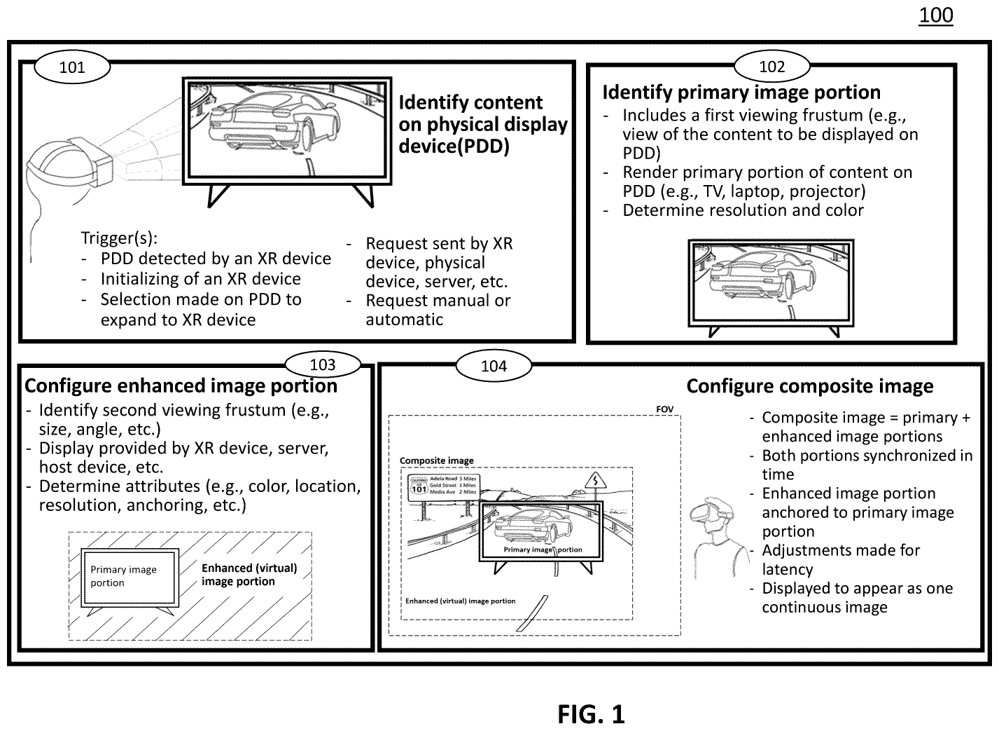

An XR device may have a field of view (FOV). The XR device FOV is typically measured as a span (in degrees) (e.g., horizontally and/or vertically). The XR device FOV is an angular extent of a scene (e.g., a user's real-world environment) presented at the display of the XR device (e.g., after the having captured the scene via one or more cameras of the XR device). The process may be initiated when an XR device identifies a PDD, or more specifically, a display associated with the PDD within its FOV. FOV may be horizontal or vertical, and references to a FOV may reference horizontal or vertical spans, or both. Note, a human eye has a horizontal FOV of roughly 135 degrees. Depending on the embodiment, the XR device FOV may be less than, equal to, or greater than the FOV of the naked eye in the same position and orientation. In any event, in some cases the PDD may have an integrated display (e.g., a TV). In some cases, the display may not be integrated. For example, the PDD may be a projector and the display may be the displayed portion shown on a canvas or canvas. In such examples, the displayed portion may be detected and utilized for the composite images or scenes described herein. The process may also be initiated when a PDD, a host device (such as a gaming console, set top box, or another processing device communicatively connected to the PDD), or a server detects the XR device within a viewable vicinity of the PDD. In other words, if a determination is made that the display of the PDD is visible in the FOV of the XR device, the process may be initiated. Accordingly, the process may be initiated by any of the devices, such as the XR device, physical device, host device, or a server. The process may also be initiated when a device specifically requests the composite image. Additional details of initiating the process, including triggers to initiate the process are described in block 101 of FIG. 1.

The process may include receiving a request to provide a composite scene, frame, or image of the content item (e.g., a composite image having a broader viewing frustum than that of the content displayed on the PDD). The request may be from the XR device to the server, the PDD to the server, or the host device to the server. The server may reside in a cloud, in a premise where the PDD and the XR device are physically present, or elsewhere and be communicatively connected to the PDD and the XR device. The composite image requested may be an image of the content item that spans across a second viewing frustum, which includes the first viewing frustum, and is larger in size than the first viewing frustum In other words, the request may be for a composite image that extends beyond the display associated with the PDD into the virtual space and includes both the primary image portion displayed on the display associated with the PDD within the first viewing frustum as well as the enhanced image portion that is overlayed on a display of the XR device and is located within the second viewing frustum. The second viewing frustum is a property of the composite image. In other words, the composite image has a second viewing frustum. The display of the XR device may be a physical component by which virtual images in an XR environment are displayed (e.g., rendered on a flat surface, projected into the eye, etc.). The display of the XR device may be two distinct surfaces or projections-one for each eye. The XR device may enable “see through,” wherein the user can view his external environment via the display of the XR device. The “see through” feature of an XR device may be either optical see through (OST) or video see through (VST; sometimes referred to as passthrough). In some instances, the display of the XR device enables OST. In such instances, the display may be or include a transparent surface through which light passes, enabling a user to view the environment around him or her. In some instances, the display of the XR device enables VST. In such instances, the display may be or include a surface that displays an image captured by cameras of the XR device. These captured images of the user's environment enable the user to see his or her environment and may give the user the impression that he is seeing “through” the display of the XR device. In some embodiments, the XR device enables both VST and OST. In any event, near-eye displays of XR devices may project an image directly into the eye (e.g., the retina) or onto a surface near the eye. For example, the display of an XR device, when the XR device is a set of AR glasses, may be the glass on which an image is presented as an “AR object” or “virtual object” to augment the scene of the real-world visible to the user through the AR glasses.

As noted, the composite image or frame has a second viewing frustum. Note, when a user views the composite image through the XR device, the composite image may take up only a portion of XR device FOV (that is, the user may view other things in his or her environment, through the XR device, other than the composite image). Said another way, the display of the XR device may depict content or imagery beyond that of the composite image (e.g., it may depict or show some of the user's environment). The composite image, which may take up only a portion of the scene visible by way of the FOV of the XR device, may be presented at the display of the XR device based on the XR device's projection hardware specifications. The FOV visible by way of the XR device may be referred to as the FOV of the XR device.

In some embodiments, the user wearing the XR device may orient from one orientation to another. Such change in orientation may result in the user observing a different image that is visible from the FOV of the XR device. Although an image or scene observed by the user via the XR device may change based on changes in the user's orientation and position, the first and second viewing frustum will not change due to such changes in the FOV of the XR device because the first and second viewing frustums are not tied to the FOV of the XR device. Rather, the viewing frustums are properties of provided content. However, in some instances, some or all of the composite image may not be displayed at the XR device due to the composite image being anchored or pinned to the display of the PDD.

Upon receiving the request for the composite image, the server may determine a primary image portion of the composite image and an enhanced image portion of the composite image. The primary image portion of the composite image is to be provided on display associated with the PDD. The primary image has a first viewing frustum. For example, the primary image portion of the composite image may be the content that is typically presented on a TV or another display device. In other words, when additional people are in the room around the PDD without XR devices, they may consume the content item by way of a “traditional” or non-enhanced content consumption experience. That is, because the additional people do not have XR devices, they consume the primary image portion without consuming the enhanced image portion. The primary image portion may be encoded and streamed from the server, such as a server for a streaming media service provider, e.g., a Netflix™ server or a gaming server in the home, such as a gaming console like Xbox™, PlayStation™, or a cloud gaming server such as Nvidia GeforceNow™, and transmitted to the PDD or the display associated with the PDD.

The server may determine the enhanced image portion of the composite image. This portion of the image corresponds to the primary image portion (e.g., it may be time synced) and may be provided via a virtual display of an XR device. The enhanced image portion may be thought of as enlarging the viewing frustum of the underlying content item output via the primary image portion. For example, football game may be available to stream via a TV. The user may simply watch the game on his TV. At any given time, a scene of this football game, as displayed, as a first viewing frustum. If desired, the user may watch the same football game via an XR device for an enhanced experience. The XR device may provide additional imagery, from the same underlying scene, around TV (e.g., as virtual or AR objects displayed on the XR device display). This additional imagery may be provided via the enhanced image portion, resulting in a composite image including both the primary image portion and the enhanced image portion. Taken together, these two portions form a composite image, which form one coherent image, have a second viewing frustum. This second viewing frustum is larger than the first viewing frustum. For example, the first viewing frustum may only show action on the field between the 30-yard line and the 50-yard line. The second viewing frustum may provide additional imagery sufficient to enable to the user to view the entire field between endzones. As a result, by providing the enhanced content portion to form the composite image, the XR device enlarges the viewing frustum associated with playback of the game at any given time.

In some embodiments, the enhanced image portion may correspond with the primary image portion. It may be thought of as representing a different portion of the same underlying content item associated with a given time-point in the content playback or streaming. In an embodiment, the enhanced image portion includes additional content that is not in the primary image portion but has image continuity with the primary image portion. For example, if the primary image portion is an image of the Eiffel Tower, the enhanced image portion is the surrounding of the Eiffel Tower and maintains image continuity from the view shown of the Eiffel Tower on the display associated with the PDD to the view shown in the enhanced image portion.

An analogy of a panoramic photo is used to describe the corresponding relationship between the primary image portion and the enhanced image portion. If a panoramic photo of the Eiffel Tower is taken, it may include the Eiffel Tower and the surrounding gardens and people. If the primary image portion is a view of the Eiffel Tower, which is a portion of the panoramic photo, the enhanced image portion may show the remainder of that panoramic photo that is not shown in the primary image portion. The enhanced image portion would be displayed as a virtual overlay at the XR device. Once displayed as a composite image, the image would appear as if it were one seamless panoramic image of the Eiffel Tower and the surroundings without a break in between, when in fact, there are two separate portions of the same image, the primary image portion, and the enhanced image portion, blended by using both physical and virtual displays to provide such an appearance.

The composite image, as described earlier, includes both the primary image portion and the enhanced image portion of the content item. The primary image portion may be viewable through the see-through equipment used by the XR device (e.g., OST or VST equipment). For example, such see-through equipment may be augmented reality glasses that allows their viewer to see real-world scenery, via transparency provided by the see-though equipment, as well as virtual content that may be presented on the XR glasses, such as overlayed on the display of the XR device.

When the composite image is displayed, i.e., with a primary image portion on the display associated with the PDD and remaining portion virtually at the XR device, both the primary and the enhanced image portions may be displayed at the same time. As such, the enhanced image portion may be synchronized with the primary image portion so as to provide the appearance of single image. The enhanced image portion may also be spatially anchored to the primary image portion.

In one example, if a user is consuming content on a TV or computer monitor, the composite image provides a larger view around the existing TV of the same content by virtually extending the display area of the content from being only on the TV to being on a larger and wider area. By doing so the composite image increases the span of the content that is to be displayed on the TV without altering the image on the TV. As such, the viewing experience of a user that is not wearing XR glasses in not altered, even though they do not see the composite image.

The process of displaying the composite image also includes determining the depth (or distance) of the primary image portion from the XR device and presenting the enhanced image portion at the same depth. Displaying both portions at the same depth (as viewed from the XR device) minimizes viewing dissonance. The process of ensuring that both primary and the enhanced image portions are displayed at the same depth relative to the XR device may include determining depth perception of the display associated with the PDD (as viewed from the XR device). In some embodiments, depth may be assessed by using various existing hardware/software tools. Some examples of existing tools include using multiple vision cameras or time-of-flight (ToF) sensors to calculate depth of an object, such as the display associated with the PDD, as viewed from an XR device. Other types of tools, such as LiDAR and depth sensing cameras, may also be used. Once the depth perception of the display associated with the PDD is determined, the enhanced image portion may be placed at the same depth as the primary image portion (which is displayed on the display associated with the PDD).

The rendering capability of the system may be analyzed and taken into consideration prior to rendering the enhanced image portion. The additional rendering, i.e., rendering of the image in the enhanced image portion, is rendering that is in addition to the rendering of the image in the primary image portion. This may also be referred to herein as over rendering. Such over rendering may increase the rendering load on the system. As such, the XR device, a server associated with the PDD, a server associated with the XR device, or a server associated with both the PDD and the XR device, may determine load capacity of the system to determine the quality of rendering in the enhanced image portion. For example, such load capacity determinations may include determining maximum floating-point operations per second (FLOPS) that the processor is capable of, and the current utilization of the processor. The XR device, or a server associated with the XR device, may also choose an over-rendering setting (e.g., a numerical parameter >1, where unity represents the view frustum on the display associated with the PDD, referred to herein as the first frustum). For example, the system may reduce the quality of rendering in the enhanced image portion, when the other counterpart of the image, i.e., the primary image portion, may still be rendered at a higher quality or whatever quality can be rendered by the PDD (e.g., 1080p, 4K, 8K resolution of the TV).

The encoding and decoding capability of the system may also be analyzed and taken into consideration prior to rendering the portion of the composite image in the enhanced image portion. A determination may be made whether an encoding unit used by the XR device, or the server is capable of encoding the portion of the image to be displayed in the enhanced image portion at least at the same rate as rendering in the primary image portion. A determination may also be made whether a decoding unit used by the XR device, or the server is capable of decoding the portion of the image to be displayed in the enhanced image portion at a pace to render at the same rate as the primary image portion. In order to encode and decode with the minimum latency, in some embodiments, encoding techniques such as grouping pictures, e.g., IP GOP techniques where the encoder uses I and P frames only, may also be used. In other embodiments, encoding for the enhanced image portion may be performed at the same rate as the encoding for physical content portion.

In some embodiments, system latency may be considered and accounted for in order to ensure that both the primary image portion and the enhanced image portion are time synchronized. When a determination is made that the network is experiencing latency, such as due to traffic congestion, and the latency is causing delay in displaying of the enhanced image portion at the XR device, the system may execute a buffering delay process and apply it to the portion of the composite image, i.e., the primary image portion, that is to be displayed on the display associated with the PDD.

The buffering delay process, in one embodiment, may include determining the amount of delay in the network, e.g., microseconds, seconds, minutes, etc. The process may include buffering frames of the primary image portion as if they are received via a content stream and instead of displaying them immediately, storing the buffered frames of the primary image portion in a storage. The system may then delay displaying of the stored frames until display of a frame from the enhanced image portion that corresponds to a frame from the primary image portion is caught up to the primary image portion. In other words, once the latency is factored in, and the frames of the enhanced image portion are buffered to match the corresponding frames in the primary image portion, then the frames of the primary image portion may be displayed.

The XR device, or a server associated with the XR device, may also execute a color-matching process to ensure that image displayed in the primary image portion and enhanced image portion, as perceived, have color continuity. For example, if a field of grass is shown in both the primary and enhanced image portion with image continuity from the first frustum to the second frustum, then the grass in both primary and enhanced images should be perceived with the same intensity of green and not have a mismatch.

In some embodiments, the color matching process may include capturing an image, using a camera associated with the XR device, of the content across multiple frames as displayed in the primary image portion. The system may calculate an average intensity across the primary image portion (which may be captured at a different resolution than the source image sent to the PDD). The system may also estimate the average brightness of pixels of the primary image portion displayed on the PDD. The system may also calculate any offsets between the average intensities of what is displayed at the PDD using the source stream and what is observed and measured via the XR device. The offsets determined may be applied to pixel intensities from the source stream for the display extensions at the renderer of the XR device. Accordingly, dissonance from unmatched colors between the primary image portion and enhanced image portion may be reduced by applying the color matching process. Optimization of configurations for such color and brightness matching can be achieved through device calibration. Discrepancy in display capabilities between the PDD and XR device as well as variation in ambient light conditions can be measured and considered in such an optimization.

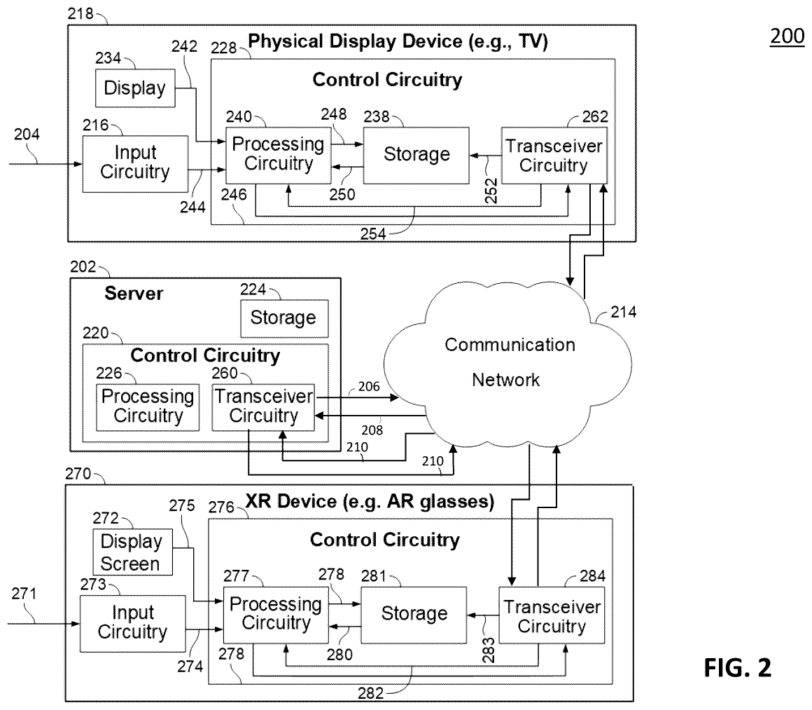

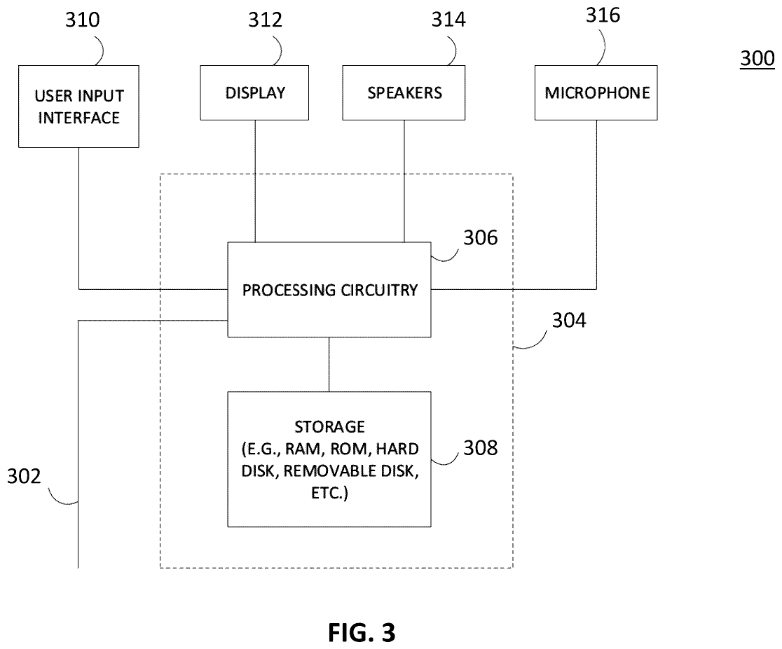

Turning to the figures, FIG. 1 is a block diagram of a process 100 of providing a composite image that extends beyond the span of a primary image displayed on display of a PDD, in accordance with some embodiments of the disclosure. The process 100 may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

The process of providing a composite image allows a user to view content at a larger span than the user would be able to view if the content were only presented on a display device, such as the TV, laptop, or a screen of a projector. For example, if the content were only displayed on the TV, it might not include additional objects or surroundings. As described in the example earlier, the TV may only show an image of the Eiffel Tower whereas the composite image may show much more. For example, the composite image may show the surrounding on the left, right, top, and bottom of the Eiffel Tower if the TV only shows a focused image of the Eiffel Tower. If a content developer desired to show more than the content that can be shown on a TV, the developer may include the additional content as a composite image. Being able to view the content as a composite image can greatly enhance viewer experience, enabling the user to view the display on a larger stage. For example, in a video game setting, where a larger view may help reveal adversaries that are otherwise not in view, such as in a first-person shooter game, being able to view the display at the larger stage may be especially beneficial.

The process 100 may utilize various techniques and components to generate and display the composite image. Some of the components of the system include a physical display device (PDD), an XR device, and a server. The components may be communicatively connected to each other via a network, as displayed in FIG. 2. Other components, as well as any attachments to the described components may also be used to generate and display the composite image. For example, a camera of the XR device may be used to detect the PDD in its field of view (FOV); a smart camera located in the same room as the PDD may be used to detect that the XR device is within a vicinity of the TV; or a dongle; such as a Roku™ Streaming Stick, or another processing device may be attached to the PDD and may be used for performing processing of the primary image portion that is to be displayed on the PDD.

The PDD, such as the PDD 218 in FIG. 2, may be a TV, or a computing device associated with a display. For example, in nonlimiting examples, the computing device may be a personal computer (PC), a laptop computer, a tablet computer, a WebTV box, a personal computer television (PC/TV), a PC media server, a PC media center, a handheld computer, a mobile telephone, a smartphone, or any device that can receive content input, process the content input, and display it on its associated display.

In some embodiments, the PDD may be a processing device that is coupled to or associated with a display. The processing device may be any device such as a set-top box, gaming console, casting stick, USB stick, streaming stick, or another device capable of receiving content input, processing the content input, such as by decoding an encoded input signal, and transmitting it to the associated display for displaying the content. Some examples of current processing devices that can be used include TiVo Edge™, Chromecast™ with Google TV™, Roku™ Streaming Stick, Amazon FireTV™ Stick, Anycast™ streaming stick, Apple TV™, Nvidia Shield™, Microsoft Xbox™, Sony PlayStation™, and Amazon Fire TV Cube™. In some embodiments the processing device may be separate from the display and in other embodiments, the processing device and the display may be one single unit, such as a smart TV.

The XR device, such as the XR device 270 of FIG. 2, may be a headset, such as an augmented reality (AR) or mixed reality (MR) headset, that is worn by the user. References herein to an “XR device” or “XR headset” refer to a device providing virtual reality (VR), mixed or merged reality (MR), or augmented reality (AR) functionality (e.g., wherein virtual objects or graphic overlays are provided in addition to real-world objects or environments visible via the device). An XR device may take the form of glasses or a headset. The described XR device may be a device that can be worn by a user by wrapping around their head, or some portion of their head, and in some instances, it may encompass the eyes of the user. It may allow the user to view both physical objects in the real world and virtual objects in the extended reality world. The virtual object may be overlayed on a display of the XR device. Such overlaying of the virtual object may be accomplished by projecting the image onto a visible surface or into the user's eyes.

In some embodiments, the XR device may be a wearable device, such as smart glasses with control circuitry 270 of system 200 displayed in FIG. 2, that allows the user to see through a transparent glass to view the display associated with the PDD and the primary image portion of the composite image as displayed on the display associated with the PDD. The XR device may possess optical see-through functionality (e.g., OST or VST functionality). In other embodiments, the XR device may be a mobile phone having a camera to intake the live feed input and display it on a display of the mobile phone. The devices mentioned may, in some embodiments, include both a front-facing (or inward-facing) camera and an outward-facing camera. The outward-facing camera may capture the live images, such as primary image portions on a TV, and augment the virtual or enhanced images anchored to the live images. For example, the outward-facing camera may capture a frame of a movie or video game being displayed on the TV and the XR device may display a virtual extension of the same frame which displays additional content, such as the surrounding of the content displayed on the TV. The devices mentioned above, such as smart glasses, mobile phones, AR/MR headsets, and the like, are used as examples for the sake of simplification, and are herein referred to as extended reality devices, XR devices, XR displays, or XR headsets.

The server, such as server 202 depicted in FIG. 2, may be connected to the PDD 218, or a processing device communicatively connected to the PDD, and XR device 270 via network 214. Process 100 may utilize one or more servers 202 to generate and display the composite image and perform associated functions. In some embodiments, process 100 may utilize server 202 to generate a composite image, identify primary and enhanced image portions of the composite image, and encode a first encoded stream carrying the primary image portion and a second encoded stream carrying the enhanced image portion. The process 100, in some embodiments, may then utilize the server 202 to transmit to the PDD or the processing device communicatively coupled to the PDD or directly to the display associated with the PDD, the first and second encoded streams, and/or transmit second encoded stream to the XR device. In other embodiments, the process, may utilize the server 202 to directly stream the second encoded stream to the XR device and only the first encoded stream is sent to the PDD. In yet other embodiments, an encoded stream of the complete over-rendered frames, i.e., the composite image is sent to the XR device.

In some embodiments, at block 101, content that is to be displayed on the display associated with the PDD is identified. The PDD may be separate from its associated display or the PDD and the display may be integrated within a single unit. Some examples of such devices include a smart TV, tablet computer, laptop computer, smartwatch, and gaming devices that can receive and display images.

In some embodiments, there may be triggers used to initiate the process of identifying content for the display associated with the PDD. To name a few, these triggers may include a) detecting the TV on an XR device, b) initializing or turning on of an XR device, c) selection made on the TV to expand span of content to an XR, and d) selection made on the TV or the XR device such as in the home screen, within a software application, or via device configuration settings. Other triggers may also be programmed such that upon the occurrence of the trigger, the process of identifying content on the TV is initiated. In addition to triggers, the devices, such as any of the devices PDD, XR device, or server may also directly request for the composite image.

At block 101, prior to identifying content for the display associated with the PDD, in one embodiment, one of the triggers to initiate the process of identifying content for the display associated with the PDD includes detection of the TV (or display associated with the PDD) by the XR device. In this embodiment, the XR device may detect the display associated with the PDD within its FOV. The XR device may utilize its outward facing camera to scan objects in its FOV and process the objects using image recognition techniques to determine whether a display associated with a PDD, such as a TV, laptop, or screen of a projector, is within its FOV. If such as display associated with the PDD has been detected, then that may be used as a trigger to identify content on the display associated with the PDD.

In another embodiment, prior to identifying content for the display associated with the PDD, one of the triggers to initiate the process of identifying content for the display associated with the PDD includes initializing of the XR device. In this embodiment, when the XR device is turned on, it may automatically scan the surrounding to determine whether a display associated with a PDD is within its FOV. If a display associated with a PDD, such as a TV, laptop, or screen of a projector, is detected, the XR device may provide an option to the user to select a composite image. Upon the user's approval, the process of identifying content for the display associated with the PDD may be initiated.

In yet another embodiment, prior to identifying content for the display associated with the PDD, one of the triggers to initiate the process of identifying content for the display associated with the PDD includes a selection made on the PDD, or the display associated with the PDD, to expand to an XR device or to display a composite image. For example, a user may be presented an option on the TV screen to extend the span of content, such as in a pop-up or in an in-line message in a user interface displayed on the TV. Upon the user's selection, the process of identifying content for the display associated with the PDD may be initiated.

In some embodiments, the trigger(s) to initiate the process of identifying content for the display associated with the PDD includes a selection made on the XR device to display a composite image. For example, a user may be presented an option on a display of the XR device to extend the span of content displayed on the TV. Upon the user's selection, the process of identifying content for the display associated with the PDD may be initiated.

Instead of a trigger, the XR device, PDD, display associated with the PDD, or a server may directly send a request for a composite image. In some embodiments, the request may be manually sent by the user using the user interface of the PDD, display associated with the PDD, user interface of the XR device, or it may be automated by the system upon activation of the trigger. In other embodiments, the XR device may request the PDD to over-render whatever content is currently being displayed on PDD.

Regardless of how the request is sent, either by a trigger or a direct request, the control circuitry, such as the control circuitry 220 of system 200 displayed in FIG. 2, which may be at a server or another device, may identify the content to be presented on the display associated with the PDD. The content, for example, may be a movie, sitcom, advertisement, television show, video game, or any other type of programming.

At block 102, the control circuitry 220 and/or 228 of server 202 may identify the primary image portion of the content image. In an example of a TV connected to a gaming console, the primary image portion may be the game as rendered by the console on the TV. In an example of a laptop, it may be the content that is typically displayed on the screen of the laptop. Such content, i.e., content of the primary image portion, has a first viewing frustum.

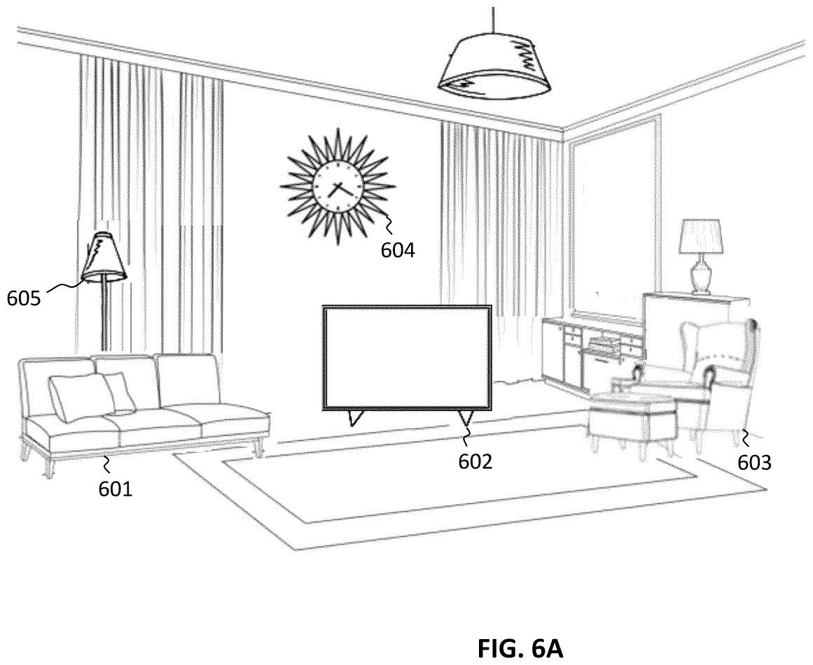

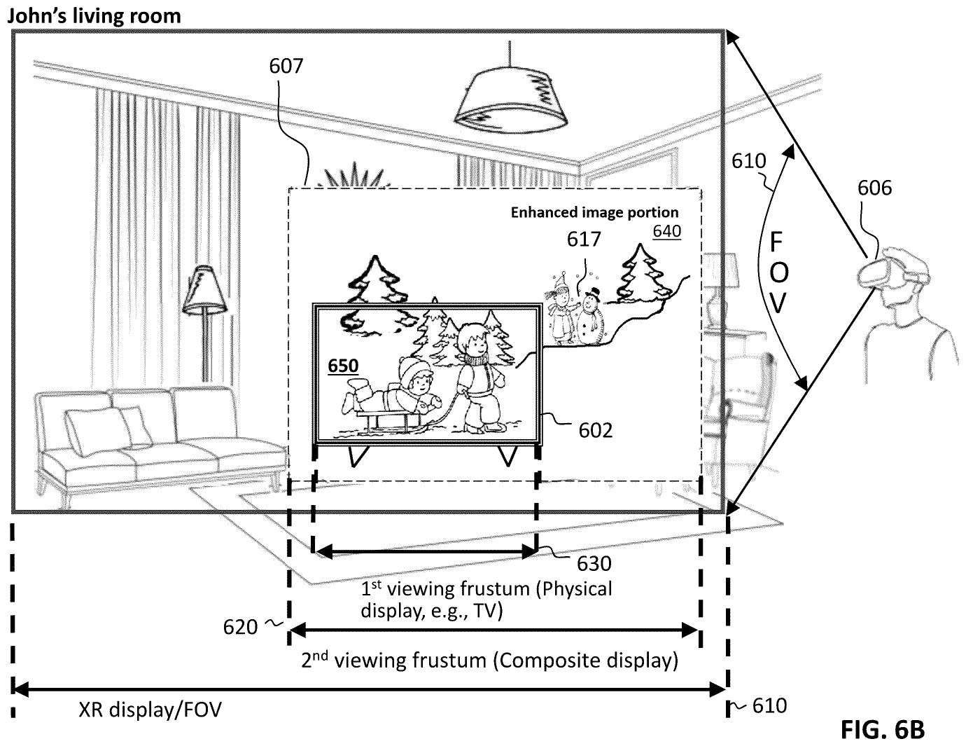

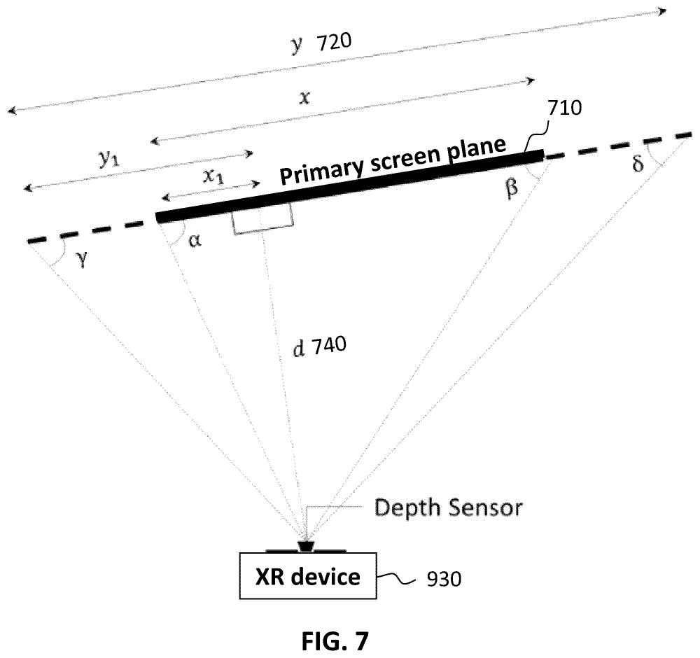

The first viewing frustum, as referred to herein is depicted at 630 in FIG. 6. The first viewing frustum, as used herein, is a property of the image or scene (or the modeled world), not the display. It is a function of the camera's view of the content presented on the display associated with the PDD, e.g., the screen of the TV itself. This first viewing frustum is the volume of the scene revealed by the assumed perspective from which the scene was captured or generated. The first viewing frustum is not tied to the user's field of view (FOV) through the XR device. As further illustrated in FIG. 7, although the image observed by the user from the XR device FOV changes as a user orients, the first viewing frustum (VF1), which is not attached to the FOV, remains spatially anchored to the PDD even as the user's image changes.

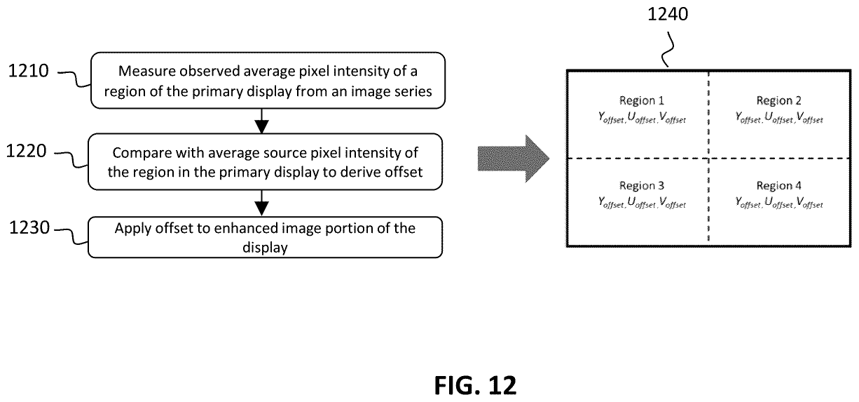

The primary image portion identified in block 102, is transmitted by a server to the display associated with the PDD. When the display and the PDD are one unit, such as a TV, it may be transmitted directly to the TV. When the display is detached from the PDD, it may be transmitted to the PDD. When another processing device is used to process images, then it may be transmitted directly to the processing device to be processed and then sent to its associated display. For example, the primary image portion may be transmitted to a processing device such as a set-top box, casting stick, USB stick, or a streaming stick (e.g., TiVo Edge™, Chromecast™ with Google TV™, Roku™ Streaming Stick, FireTV™ Stick, etc.) or another type of local console that is capable of processing received image portions. The resolution and colors of the primary image portion may be determined for subsequently matching it with the enhanced image portion, as will be described further below and in reference to FIG. 12. In some embodiments, other display attributes associated with display of the primary image portion (e.g., size of TV) may also be identified for subsequent analysis and use.

At block 103, the control circuitry 220 and/or 276 may configure the enhanced image portion of the composite image. The enhanced image portion display may be used to display virtual content (e.g., a virtual object, item, or overlay) that provides an extended span of the primary image portion. In the example of the primary image portion being displayed on the TV, the enhanced image portion is located virtually outside the TV and displayed as a virtual image rendered by the XR device around the TV, and spatially anchored to the TV.

As part of the process for configuring the enhanced image portion display, the control circuitry 200 and/or 276 may identify a second viewing frustum within which the enhanced image portion display is to be displayed. The second viewing frustum, as depicted at 620 in FIG. 6 and viewing frustum 2 (VF2) 720 in FIG. 7, includes the first viewing frustum. The content and image to be displayed within the enhanced portion of the image is a portion of a scene falling outside the first viewing frustum. The second viewing frustum refers to a volume of the content that is to be displayed as a composite image at that includes both the primary image portion and the enhanced image portion. Because the primary image portion is already provided by the PDD, the scene depicted by the enhanced image portion is a portion falling outside the scene depicted in the primary image portion. When displayed, the enhanced image portion is positioned and oriented outside of the physical display. The enhanced image portion may be thought of as having a “cut out” corresponding to the primary image portion and the physical display.

The enhanced image portion may be provided by the XR device. In other embodiments, the enhanced image portion display may also be provided by the server or a host device, such as a gaming module communicatively connected to the XR device.

The enhanced image portion relates and corresponds to the primary image portion. It may be considered a different portion of the same content item but shown virtually by the XR device instead of on a display associated with the PDD. The enhanced image portion item may include additional content that is not in the primary image portion but has image continuity with the primary image portion. For example, referring to FIG. 6, the enhanced image portion 640 includes a ceiling light and love seat that are not in the primary image portion 650.

The XR device may determine size, depth, and other attributes of the primary image portion and communicate these, along with its own capabilities, to the processor for making decisions on the attributes of the enhanced image portion. Alternatively, the XR device may make some or all of the decisions related to the attributes of the enhanced image portion and communicate these to the processor. The attributes communicated may include attributes related to color and resolution of the enhanced image portion. Such attributes may depend on the XR device's capabilities, such as rendering and encoding capabilities.

Size of the enhanced image portion display may be determined based on a plurality of factors. It may also depend on the type of application, such as a movie, video game, etc. For example, if the application is a game, then appearance of people and objects may make the game more likely to be immersive. As such, the desire may be to generate an enhanced image portion that is large enough to make the objects and people look lifelike. Another factor considered in determining the size of the enhanced image portion display may be the rendering load. Since a larger span means having to render a greater number of objects thereby increasing the rendering load on the system, the system capabilities may be considered so as not to overburden the system. One such system capability considered is the processor's encoding and decoding capabilities. This may be considered for both the processor associated with the PDD and the XR device. For example, based on the capabilities of the processor associated with the XR device, the extent of the enhanced image, such as its quality, size, etc., may be limited such as not to overburden the processor.

User comfort level may also be taken into consideration in determining the size of the enhanced image portion display. If the size of the enhanced image portion display is too small that may not help the user and may be closer to just having the TV on its own. In other words, a minimal additional to the size of the primary image portion displayed virtually may not add much more to the user experience. On the other hand, if the size of the enhanced image portion display is too large, such as in a non-gaming setting, that may require the user to move their head in different directions to capture the full image thereby overburdening them. The XR device, together with the processor, may determine an optimal size or a length and width that would enhance user experience and provide them an optimal amount of additional content to view.

Configuring the enhanced image portion display may also include determining whether the colors of the enhanced image portion match the colors of the primary image portion. Since content displayed in the enhanced image portion display is a wider span of the same content as displayed in the primary image portion, when both are displayed together, they should have an appearance to a user wearing the XR device, of being one single display. In other words, the primary and enhanced image together should have the appearance of one coherent image. Having color continuity may providing such an appearance. The XR device, or a server associated with the XR device, may execute a color matching process to ensure that a color match of the enhanced image portion to that of the primary image portion is achieved. Such a color matching process may include capturing an image of the content across multiple frames as displayed in the primary image portion and calculating an average intensity. The system may also estimate the average brightness of pixels of the primary image portion displayed on the PDD. The system may also calculate any offsets between the average intensities of what is displayed in the primary image portion and what is displayed and measured via the XR device. The offsets determined may be applied to pixel intensities from the source stream for the display extensions at the renderer of the XR device. Accordingly, dissonance from unmatched colors between the primary image portion and enhanced image portion may be reduced by applying the color matching process.

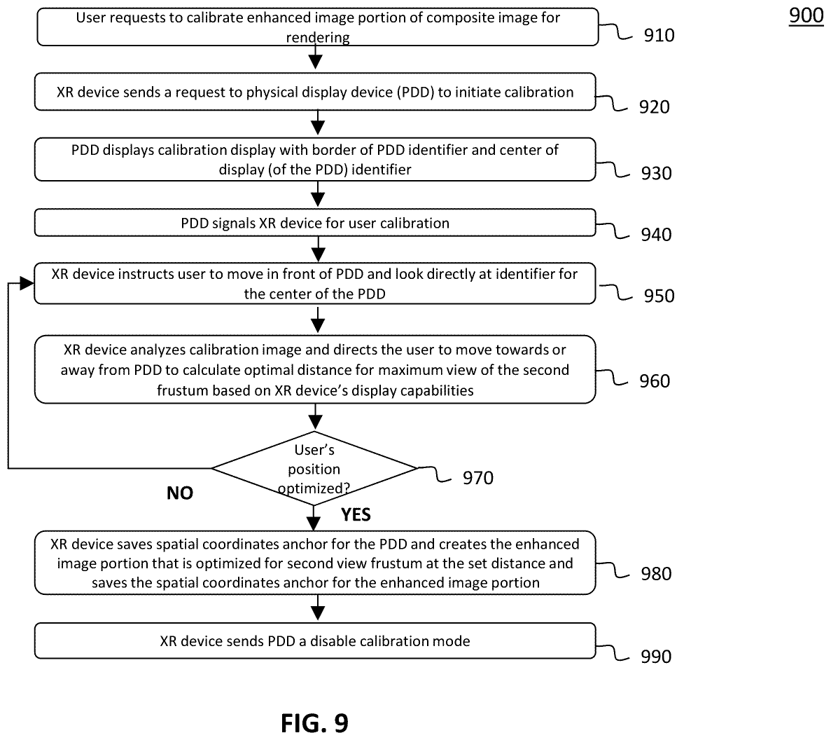

Configuration of the enhanced image portion may also include anchoring the enhanced image portion to the primary image portion. Since the enhanced image portion is to maintain image continuity with the primary image portion, anchoring it to the primary image portion would allow the control circuitry, such as control circuitry 220 and/or 276 to maintain a spatial relationship between the two image portions. A calibration process may also be applied from time to time, or on set periodic intervals, to ensure that the anchoring is accurate of determine if any adjustments need to be made to maintain the spatial relationship. One example of such a calibration process is described in relation to FIG. 9.

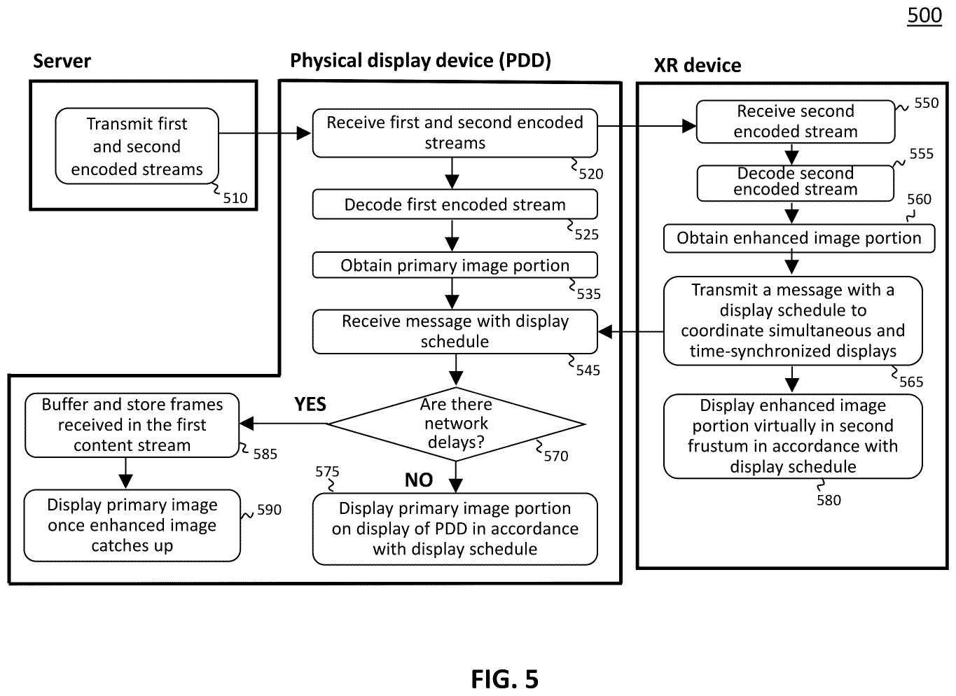

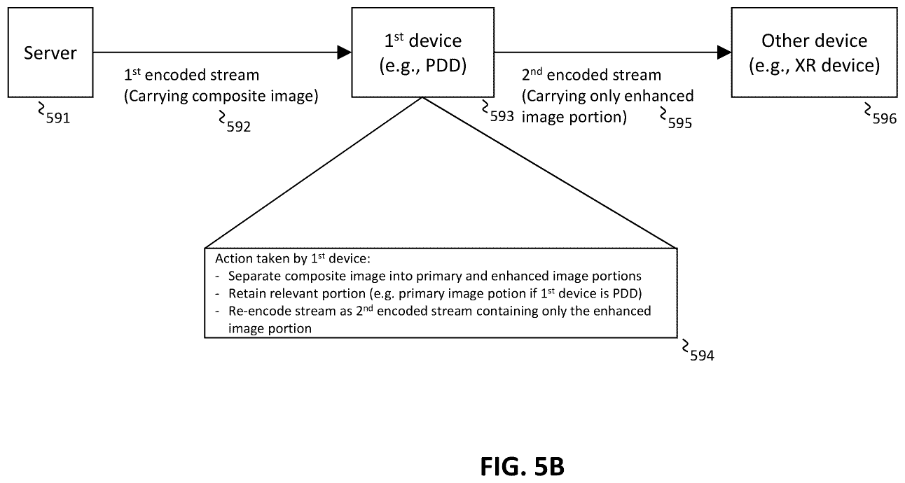

At block 104, in some embodiments, a composite image that includes both the primary image portion and the enhanced image portion is generated. The primary image portion and the enhanced image portion display are synchronized in time such that the composite image displayed, which includes both image portions, provides an appearance of a single display that spans from the display associated with the PDD into the virtual space where the enhanced image portion is displayed by the XR device. If rendering both the primary image portion and the enhanced image portion display cannot be immediately time-synchronized due to network latency, then frames of the primary image portion may be buffered and stored until the rendering of the enhanced image portion display catches up to the primary image portion, thereby providing time synchronization between the portions of the composite image over time. The process of synchronizing the primary image portion and the enhanced image portion display in time is further described in relation to FIG. 5.

The enhanced image portion, in some embodiments, is spatially anchored to the primary image portion. Anchoring the enhanced image portion to the primary image portion ensures the enhanced image portion is aligned with the primary image portion in such a way that it provides the appearance of one continuous image with no breaks or gaps in-between. To anchor the primary image portion to the enhanced image portion, in some embodiments, a calibration may be performed. The calibration is used to determine and maintain the spatial relationship between the primary image portion and enhanced image portion.

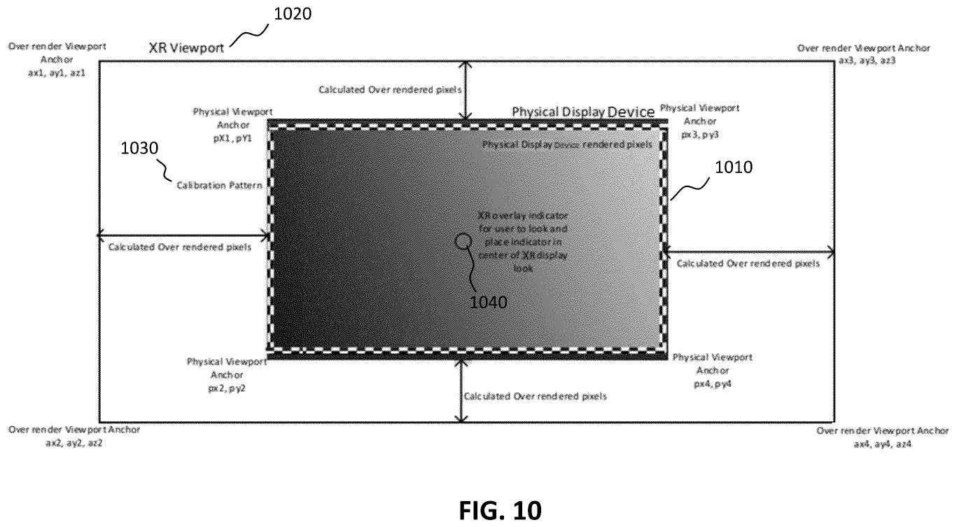

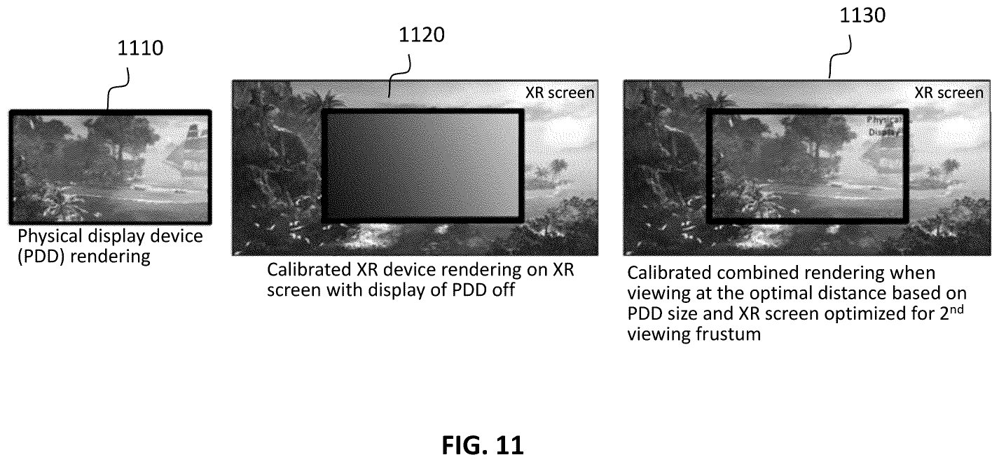

Calibration is also used to determine the extent of the virtual extensions from the primary image portion. The user wearing the XR device may be prompted to perform certain actions, such as moving closer to and farther from the display associated with the PDD to calibrate the primary image portion with the enhanced image portion. Details of the calibration process are described in further detail in relation to FIGS. 10 and 11.

The enhanced image portion display also has image continuity from the primary image portion. Image continuity with no break or gaps in-between provides an appearance of a single display with one coherent image that spans the display associated with the PDD into the virtual space where the enhanced image portion is displayed by the XR device. In some embodiments, the frame of the display associated with the PDD, such as the frame around the TV, may give the appearance of a break between the primary image portion and the enhanced image portion. To compensate for this break, the shape, size, and design of the frame around the TV may be analyzed and the portion of the enhanced image may be overlayed on the frame of the TV to give the appearance of a continuous display without a gap. Having such continuity, as mentioned earlier, gives the perception to a user wearing the XR device of one continuous display having a larger span than just the PDD.

FIGS. 2 and 3 also describe example devices, systems, servers, and related hardware that may be used to implement processes, functions, and functionalities described at least in relation to FIGS. 1, 4-5, and 6B-15. FIG. 2 is a block diagram of an example system for providing a composite image that extends the span of a primary image displayed on the display of a PDD and FIG. 3 is a block diagram of an XR device used for displaying the composite image, in accordance with some embodiments of the disclosure.

In some embodiments, FIGS. 2 and 3 may be used for identifying a content item to be displayed at a PDD according to a first viewing frustum, receiving a request to provide, at an XR device, a composite image of the content item that spans across a second viewing frustum, determining a primary image portion of the composite image to be displayed at the physical display associated with the PDD, where the primary image portion spans a first viewing frustum, determining an enhanced image portion of the composite image that corresponds to the primary image portion and that is to be displayed virtually within the second viewing frustum and outside the first viewing frustum, where the enhanced image portion maintains image continuity with the primary image portion, providing, at a display of the XR device, the composite image including the primary image portion and enhanced image portion of the content item by displaying as a see-through at the display of the XR device, the primary image portion that is displayed on the physical display associated with the PDD, where the see-through allows viewing the primary image portion via the display of the XR device and generating for display, at the display of the XR device, the enhanced image portion of the composite image such that the displaying of the enhanced image portion is time-synchronized with the display of the primary image portion and such that the enhanced image portion is spatially anchored to the primary image portion and performing functions related to all other processes and features described herein.

In some embodiments, one or more parts of, or the entirety of system 200, may be configured as a system implementing various features, processes, functionalities and components of FIGS. 1, 4-5, and 6B-15. Although FIG. 2 shows a certain number of components, in various examples, system 200 may include fewer than the illustrated number of components and/or multiples of one or more of the illustrated number of components.

System 200 is shown to include a PDD 218, a server 202, and XR device 270, and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to PDD 218 and XR device 270 through communication network 214. While not shown in FIG. 2, server 202 may be directly communicatively coupled to PDD 218 and/or XR device 270, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes PDD 218 and/or XR device 270, and functionality that would otherwise be implemented by PDD 218 is instead implemented by other components of system 200, such as one or more components of communication network 214 or server 202 or a combination. In still other embodiments, PDD 218 and/or XR device 270 works in conjunction with one or more components of communication network 214 or server 202 to implement certain functionality described herein in a distributed or cooperative manner.

PDD 218 includes control circuitry 228, display 234 and input circuitry 216. Control circuitry 228 in turn includes transceiver circuitry 262, storage 238 and processing circuitry 240.

XR device 270 includes control circuitry 276, display 272 and input circuitry 273. Control circuitry 276 in turn includes transceiver circuitry 284, storage 281 and processing circuitry 277. In some embodiments, XR device 270 or control circuitry 276 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238, and/or 281 may be used to store various types of content (e.g., primary image portion, enhanced image portion, composite display, depth of the PDD from the XR device, calibration data, including spatial relationship between the primary image portion and enhanced image portion, color matching data, and pixel intensity of the PDD). Non-volatile memory may also be used (e.g., to render the enhanced image portion on the display of the XR device). Cloud-based storage may be used to supplement storages 224, 238, 281 or instead of storages 224, 238, and 281. In some embodiments, data relating to primary image portion, enhanced image portion, composite display, depth of the PDD from the XR device, calibration data, including spatial relationship between the primary image portion and enhanced image portion, color matching data, and pixel intensity of the PDD, and data relating to all other processes and features described herein, may be recorded and stored in one or more of storages 212, 238, and 281.

In some embodiments, control circuitries 220 and/or 228 and 276 executes instructions for an application stored in memory (e.g., storage 224 and/or storage 238 and 281). Specifically, control circuitries 220 and/or 228 and 276 may be instructed by the application to perform the functions discussed herein. In some implementations, any action performed by control circuitries 220 and/or 228 and 276 may be based on instructions received from the application. For example, the application may be implemented as software or a set of executable instructions that may be stored in storage 224 and/or 238 and 281 and executed by control circuitries 220 and/or 228 and 276. In some embodiments, the application may be a client/server application where only a client application resides on PDD 218 and/or XR device 270, and a server application resides on server 202.

The application may be implemented using any suitable architecture. For example, it may be a stand-alone application wholly implemented on PDD 218 and/or the XR device 270. In such an approach, instructions for the application are stored locally (e.g., in storage 238 or 281), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, once the primary image portion has been determined, the control circuitry 228 may send instructions to the PDD that may be used to display the primary image portion in a synchronous manner with the enhanced image portion to provide the appearance of one single coherent image. It may also perform steps of processes described in FIGS. 1, 4-5, 8-9, and 12-15.

Control circuitry 276 may retrieve instructions for the application from storage 281 and process the instructions to perform the functionality described herein. Based on the processed instructions, control circuitry 276 may determine a type of action to perform in response to input received from input circuitry 273 or from communication network 214. For example, once the enhanced image portion has been determined, the control circuitry 276 may send instructions to the XR device that may be used to display the enhanced image portion in a synchronous manner with the primary image portion to provide the appearance of one single coherent image. It may also perform steps of processes described in FIGS. 1, 4-5, 8-9, and 12-15.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 or 276 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. PDD 218 may receive the content to be displayed that is generated by the remote server and may display the content of the displays locally via display 234. This way, the processing of the instructions is performed remotely (e.g., by server 202) while the resulting displays, such as the display windows described elsewhere herein, are provided locally on PDD 218. PDD 218 may receive inputs from the user via input circuitry 216 and transmit those inputs to the remote server for processing and generating the corresponding displays. Alternatively, PDD 218 may receive inputs from the user via input circuitry 216 and process and display the received inputs locally, by control circuitry 228 and display 234, respectively. Likewise, XR device 270 may receive the displays generated by the remote server and may display the content of the displays locally via display 272. This way, the processing of the instructions is performed remotely (e.g., by server 202) while the resulting displays, such as the display windows described elsewhere herein, are provided locally on the display of the XR device 270. XR device 270 may receive inputs from the user via input circuitry 273 and transmit those inputs to the remote server for processing and generating the corresponding displays. Alternatively, XR device 270 may receive inputs from the user via input circuitry 273 and process and display the received inputs locally, by control circuitry 276 and display 272, respectively.

Server 202 and PDD 218 may transmit and receive content and data such as primary image portion to be displayed on the PDD. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that PDD 218 is not limited to the embodiments and methods shown and described herein. In nonlimiting examples, PDD 218 may be an electronic device, a personal computer (PC), a laptop computer, a tablet computer, a WebTV box, a personal computer television (PC/TV), a PC media server, a PC media center, a handheld computer, a mobile telephone, a smartphone, any other device, computing equipment, or wireless device, and/or combination of the same capable of displaying a primary image portion.

Server 202 and XR device 270 may transmit and receive content and data such as enhanced image portion to be displayed on a display of the XR device 270. Control circuitry 220, 276 may send and receive commands, requests, and other suitable data through communication network 214 using transceiver circuitry 260, 284, respectively. Control circuitry 220, 276 may communicate directly with each other using transceiver circuits 260, 284, respectively, avoiding communication network 214.

It is understood that XR device 270 is not limited to the embodiments and methods shown and described herein. In nonlimiting examples, XR device 270 may be an electronic device, an augmented reality device, a virtual reality device, a mixed reality device, and any other device capable of displaying an enhanced image portion.

Control circuitries 220 and/or 218 and/or 276 may be based on any suitable processing circuitry such as processing circuitry 226 and/or 240 and/or 277, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitries 220 and/or control circuitry 218 and/or 276 are configured for identifying a content item to be displayed at a PDD according to a first viewing frustum, receiving a request to provide, at an XR device, a composite image of the content item that spans across a second viewing frustum, determining a primary image portion of the composite image to be displayed at the physical display associated with the PDD, where the primary image portion spans a first viewing frustum, determining an enhanced image portion of the composite image that corresponds to the primary image portion and that is to be displayed virtually within the second viewing frustum and outside the first viewing frustum, where the enhanced image portion maintains image continuity with the primary image portion, providing, at a display of the XR device, the composite image including the primary image portion and enhanced image portion of the content item by displaying as a see-through at the display of the XR device, the primary image portion that is displayed on the physical display associated with the PDD, where the see-through allows viewing the primary image portion via the display of the XR device and generating for display, at the display of the XR device, the enhanced image portion of the composite image such that the displaying of the enhanced image portion is time-synchronized with the display of the primary image portion and such that the enhanced image portion is spatially anchored to the primary image portion and performing functions related to all other processes and features described herein.

Transmission of user input 204 to PDD 218 or input 204 to XR device 270 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4-5, 8-9, and 12-15, respectively.

Likewise, processing circuitry 277 may receive input 271 from input circuit 273. Processing circuitry 277 may convert or translate the received user input 271 that may be in the form of voice input into a microphone, or movement or gestures to digital signals. In some embodiments, input circuitry 273 performs the translation to digital signals. In some embodiments, processing circuitry 277 (or processing circuitry 226, as the case may be) carries out disclosed processes and methods. For example, processing circuitry 277 or processing circuitry 226 may perform processes as described in FIGS. 1, 4-5, 8-9, and 12-15, respectively.

FIG. 3 is a block diagram of an XR device used for displaying the composite image, in accordance with some embodiments of the disclosure. The equipment device 300 may receive content and data via input/output (I/O) path 302. The I/O path 302 may provide audio content (e.g., such as in the speakers of an XR headset). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 304 may include communications circuitry suitable for receiving a request to provide a composite image of the content item that spans across a second viewing frustum, determining an enhanced image portion of the composite image that corresponds to the primary image portion and that is to be displayed virtually within the second viewing frustum and outside the first viewing frustum, where the enhanced image portion maintains image continuity with the primary image portion, providing, at a display of the XR device, the composite image by displaying as a see-through at the display of the XR device, where the see-through allows viewing the primary image portion via the display of the XR device and generating for display the enhanced image portion of the composite image such that the displaying of the enhanced image portion is time-synchronized with the display of the primary image portion and such that the enhanced image portion is spatially anchored to the primary image portion and performing functions related to all other processes and features performed by the XR device as described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., enhanced image portion, composite display, depth of the PDD from the XR device, calibration data, including spatial relationship between the primary image portion and enhanced image portion, and color matching data). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be an optical see through (OST) or video see through (VST; sometimes referred to as passthrough). The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as XR device 272, but any other type of user equipment suitable for allowing communications between two separate user devices for performing the processes described in this application, such as processes described in FIGS. 1, 4-5, 8-9, and 12-15.

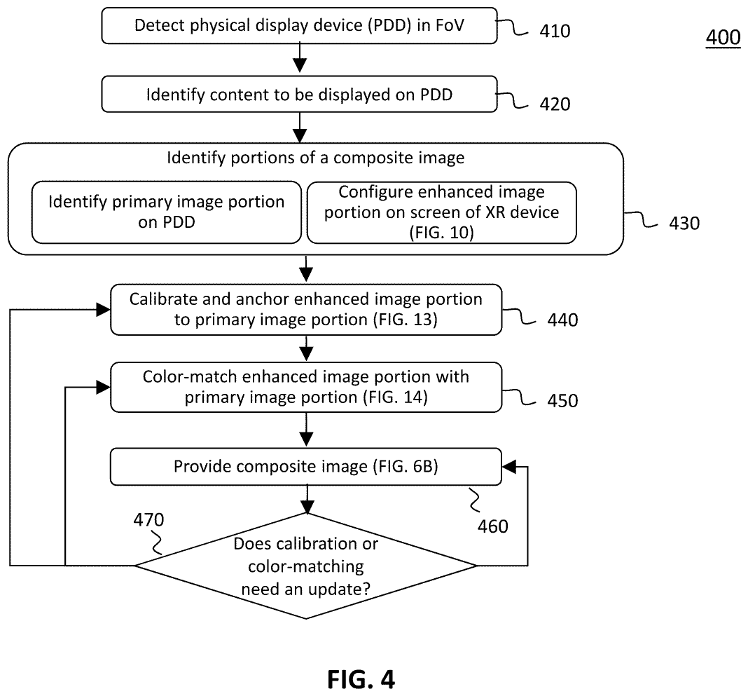

FIG. 4 is a flowchart of a process for providing a composite image that includes primary and enhanced image portions of the composite image, in accordance with some embodiments of the disclosure.

The process 400 may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the process 400.

Providing a composite image extends and increases the span of content using an XR device when a user is consuming the content on a main screen or display associated with a PDD, such as a TV or a computer monitor. The span extension may be horizontal, vertical, or combination thereof.

The composite display integrates the content displayed on the display associated with the PDD and adds the virtual portion to it. In other words, the composite image integrates the primary image portion displayed on the display associated with the PDD and adds the enhanced image portion that is displayed virtually to provide an appearance of a single coherent image.

This is different from existing solutions that provide a second screen, such as a second monitor to a main monitor since such solutions do not increase the span of the same content and do not integrate the content on the main monitor to present a composite image.

In the embodiments described herein, the user may continue to watch the content presented in a primary image portion that is displayed on a display associated with the PDD in a see-through mode on their XR device, such as AR glasses and also see simultaneously the enhanced image portion of the same content overlayed virtually at the display of their XR device. The integration of both the primary and enhanced image portions may be presented as a larger screen around the existing display associated with the PDD, e.g., the TV's flatscreen display for the XR device user.

The process 400 of generating a composite image, which includes generating a virtual extension (i.e., the enhanced portion of the image around the display) may be applied to any suitable display device, such as smart TV, desktop, laptop computer, tablet, smart watch, display screen used to project an image from a projector, a movie theatre screen, heads up display in an automobile, or navigation screen of an automobile.

In nonlimiting examples, some of the applications where a composite image may be generated include gaming, consuming content on a TV or any widescreen video, and consuming content on a computer screen/at a workplace. For example, in a video gaming application, typically the size of content, such as objects and people, rendered in a game is a decision made by a developer of the game. The developers may consider several factors in designing the game. For example, if the appearance of people and objects are “lifelike,” then the video game is likely to be more immersive. As such, objects are rendered keeping in mind typical screen sizes and distances, especially in first person views. Another factor considered may be the ability of the experience to be rendered. The wider the span, typically, the greater the number of objects to be rendered in the game since all objects within the view frustum must be rendered. Developers may choose to increase the scale factor of all objects in the scene to reduce rendering load, but this may adversely affect the appearance of lifelikeness (all objects will now appear closer). As such, application of process 400 to generate a composite image that is both lifelike and is not tied to size of a physical display may be highly advantageous as it virtually extends the span of the content item beyond the PDD.

In a computer application, such as at a workspace, the application of process 400 to generate a composite image may allow a user to extend their work environment beyond a physical computer screen by having an enhanced image portion that virtually extends the span. Having such a virtual extension may provide a user a significantly greater area to organize and view their applications.

In a TV or widescreen video application, a streaming video may be delivered in a widescreen or immersive format. While the viewer continues to watch a TV screen, the AR glasses provide a larger stage by extending the scene into a panorama (e.g., VR180 format). These are just a few non-limiting applications of process 400.

The process 400, in some embodiments, may include the control circuitry 220 and/or 228 and/or 276 detecting a physical display device (PDD) in a user's FOV through the XR device (i.e., the FOV of the XR device), as depicted at block 410. In some embodiments, the PDD may be a separate device that may be communicatively connected to a display, such as projector to a projection screen or a processing device to a display. Some examples of such processing devices may include a TiVo Edge™, Chromecast™ with Google TV™, Roku™ streaming stick, FireTV™ stick, Anycast™ streaming stick, Apple TV™, Nvidia Shield™ and Amazon Fire TV Cube™. In other embodiments, the display may be integrated within a single unit, such as smart TV, tablet computer, laptop computer, smartwatch, and/or gaming device that can receive and display images.

Detection of the display associated with the PDD, or a single-unit PDD with a display, may be performed by the XR device using its outward facing camera. In this embodiment, the control circuitry associated with the XR device may scan objects in its FOV and use image recognition techniques to process the objects scanned. The image recognition techniques, along with AI or ML processes, may be used to determine whether a scanned image includes a display associated with the PDD, or a single-unit PDD with a display.

In some embodiments, other devices located in the same room or within the vicinity of the PDD or display associated with the PDD may be used to perform the detection. For example, a smart camera located in the same room as the PDD may be used to detect that the XR device is within a vicinity of the TV.

Detection of the display associated with the PDD, or a single unit PDD with a display may be used as a trigger at block 420 to identify content to be displayed on the display associated with the PDD. Other triggers to initiate the process of identifying content to be displayed on a display associated with the PDD may include a) detecting the TV on an XR device, b) initializing or turning on of an XR device, and c) selection made on the TV to expand span of content to an XR device. Any of the devices, such as PDD, XR device, or server may also directly request for the composite image which may trigger the process of identifying content to be displayed on a display associated with the PDD.

The content identified at block 420 may be by the control circuitry 220 of system 200 displayed in FIG. 2, which may be at a server or another device. The content identified may be a movie, sitcom, advertisement, television show, video game, or any other type of programming. If the content is to be displayed on a TV, it may be any content that a cable or an OTT provider has designated to be presented on the TV.

At block 430, the control circuitry, such as control circuitry 220 may identify portions of a composite image, i.e., what content is to be presented in each portion. The composite image may include two portions, a primary image portion and an enhanced image portion. The primary image portion is simply the content that is typically displayed on the TV. In an example of a laptop, it is the content that is typically displayed on the screen of the laptop. It is the content identified in block 420 as the content to be displayed on the PDD or display associated with the PDD when the display is a separate unit from the PDD.

The primary image portion has a first viewing frustum. This viewing frustum is a property of the image or scene (or the modeled world) and is a camera's view of the content presented on the display associated with the PDD. The first viewing frustum is not tied to XR device FOV. As such, even if the scene observed by the user of the XR device changes, the first viewing frustum (as depicted in FIGS. 6 and 7) does not change since it remains anchored to the display associated with the PDD.

The primary image portion is transmitted by a server to the display associated with the PDD. When the display and the PDD are one unit, such as a TV, it may be transmitted directly to the TV. When the display is detached from the PDD, it may be transmitted to the PDD. When another processing device is used to process images (such as a USB stick, gaming console, or a streaming stick), then it may be transmitted directly to the processing device to be processed and then sent to its associated display.

Identification of portions of the composite image includes identifying the enhanced image portion. The enhanced image portion of the composite image is used to display virtual content that provides an extended span of the primary image portion. In some embodiments, the developers of the composite image may design content that is to be presented virtually in this enhanced image portion. This may be content that is in addition to the content presented in the primary image portion but content that is contextually related to the primary image portion and content that is developed such that image continuity is maintained from the primary image portion to the enhanced image portion. In other words, the content presented in the primary image portion and the enhanced image portion is the same content but with a larger span.

What is to be designated as content to be presented in the enhanced image portion may depend on a plurality of factors. One of the factors considered may be the size and location of the enhanced image portion. Accordingly, the control circuitry 200 and/or 276 may identify a second viewing frustum within which the enhanced image portion display is to be displayed. The second viewing frustum, as depicted at 620 in FIG. 6 and VF2 720 in FIG. 7, includes the first viewing frustum. The content and image to be displayed within the second viewing frustum is displayed only outside the first viewing frustum. The size of this second viewing frustum may be determined based on any one or more of type of applications, rendering load on the system, encoding and decoding capabilities of the system, FOV of the XR device, user comfort, and resolution of image in the primary image portion.

In terms of type of application, the developers may choose to use different sizes of enhanced image portions from one application to another. For example, lifelike size may be preferred in gaming applications, whereas just a wider span to cover additional objects may be preferred in a movie consuming application. Accordingly, the size and span of the enhanced image may be based on its use case, and it may vary even within a use case. For example, some segments of a movie or a game may have a larger enhanced image portion, i.e., a larger span that shows more content; some segments of a movie or a game may have a smaller span, and some segments of a movie or a game may not have an enhanced image portion at all. As the movie or game timeline progresses, different-sized second viewing frustums may be used.

Another factor considered in determining the size of the enhanced image portion display may be the rendering load. Since a larger span means having to render a greater number of objects thereby increasing the rendering load on the system, the system capabilities, such as the XR device capabilities, may be considered by the developers so as not to overburden the system.

Another factor considered in determining the size and location of the enhanced image portion display may be the user's comfort level. The developers may aim to have an optimal sized second view frustum that is not too small and not too large for displaying the enhanced image portion. If the size of the enhanced image portion display is too small, an enhanced image portion may not help the user and may be closer to just having the TV on its own. In other words, a minimal additional to the size of the primary image portion displayed virtually may not add much more to the user experience compared to how much more a larger span extension may add.

Another factor considered in determining the size and location of the enhanced image portion display may be the resolution of the image in the primary image portion. For example, if the resolution in the primary image portion is a high resolution, to generate a large, enhanced image portion with the same image resolution may require a lot more rendering load than generating a smaller-sized enhanced image portion.

Since the composite image is presented over two separate devices, i.e., the primary image portion displayed on the display associated with the PDD within the first view frustum and the enhanced image portion displayed as a virtual object or overlay at the display of the XR device, thereby providing a composite image having the second view frustum. The composite image provides the look and feel of a single display. To provide this uniform composite image, anchoring, calibration, and/or color matching processes may be performed.

The calibration and anchoring processes may include, as depicted at block 440, a process to calibrate and anchor the enhanced image portion to the primary image portion. The calibration and anchoring processes may ensure that the enhanced image portion is spatially tied to the primary image portion such that image continuity across the primary image portion and enhanced image portion can be achieved. The calibration process may be applied from time to time, or on set periodic intervals, to ensure that the anchoring is accurate or determine if adjustments are made as needed to maintain the spatially connected relationship. One example of such a calibration process is described in relation to FIG. 9.

The color matching process at block 450, may include a process to color-match the enhanced image portion with the primary image portion. The color matching process, in some embodiments, may include capturing an image of the content across multiple frames as displayed in the primary image portion and calculating an average intensity. The system may also calculate the average intensity of pixels for the primary image portion from a source stream received by the physical display. The system may also calculate offsets between the average intensities of what is displayed in the primary image portion and what is observed via the XR device. The offsets determined may be applied to pixel intensities from the source stream for the display extensions at the renderer of the XR device. Accordingly, dissonance from unmatched colors between the primary image portion and enhanced image portion may be reduced by applying the color matching process. One example of such a color matching process is described in relation to FIG. 12.

At block 460, a composite image may be provided, such as the composite image 620 in FIG. 6B. The composite image may include both the primary image portion (provided by the PDD) and the enhanced image portion (generated and/or displayed by the XR device) displayed simultaneously and time-synchronized. If rendering both the primary image portion and the enhanced image portion display cannot be immediately time-synchronized due to network latency, then frames of the primary image portion may be buffered and stored until the rendering of the enhanced image portion display catches up to the primary image portion, thereby enabling time-synchronization The process of providing the composite image is further described in relation to FIG. 5.

At block 470, the control circuitry, such as control circuitry 220 and/or 276 may determine whether an update in calibration or the color-matching is needed. Based on the application, the second view frustums may change in size, and the content displayed in the enhanced image portion may change in size and color from segment to segment, such as in a movie or game. As such, a process to ensure that the enhanced image portion continues to be spatially tied accurately with the primary image portion and maintains color and image continuity may be applied. If a determination is made at block 470 that either the anchoring or color-matching needs an update, such as due to it not being in sync with the primary image portion, then the process may move back to blocks 440 or 450 as needed. The update may be provided as needed after each segment or scene change to ensure image and color continuity between the primary image portion and enhanced image portion.

FIG. 5 is a flowchart of communications between a server, PDD and XR device for transmitting and displaying a composite image, in accordance with some embodiments of the disclosure.

The process 500 may be implemented, in whole or in part, by systems or devices such as those shown in FIGS. 2-3. One or more actions of the process 500 may be incorporated into or combined with one or more actions of any other process or embodiments described herein. The process 500 may be saved to a memory or storage (e.g., any one of those depicted in FIGS. 2-3) as one or more instructions or routines that may be executed by a corresponding device or system to implement the process 500.

In some embodiments, at block 510, control circuitry of a server, such as control circuitry 220 of FIG. 2, may transmit first and second encoded streams to the PDD. If the PDD is a separate device that is communicatively connected to a display, then the first and second encoded streams may be provided to the PDD and not to its associated display since it may be the PDD that may perform the processing of the received streams. Such processing of the streams includes decoding and rendering the decoded streams to the display. Similarly, if the PDD is associated with a processing device that performs the function of receiving streams and processing them, then the first and second encoded streams may be transmitted to the processing device for processing of the streams. In other embodiments, first and second encoded streams are sent separately to the PDD and the XR device respectively.

The first encoded stream transmitted by the server may include the primary image portion of the composite image. The primary image portion included in the first media stream may be a movie, sitcom, advertisement, television show, video game, or any other type of programming. If the content is to be displayed on a TV, it may be any content that a cable or an OTT provider has designated to be presented on the TV. The primary image portion transmitted in the first encoded stream transmitted may be designated to be displayed in the first view frustum.

The second encoded stream transmitted by the server may include the enhanced image portion of the composite image. The enhanced image portion is contextually related to the primary image portion and is a larger span of the same content as in the primary image portion. The enhanced image portion included is content that is not presented in the primary image portion. The primary image portion and the enhanced image portion together form a coherent single image that has spatial and color continuity. The enhanced image portion transmitted in the second encoded stream may be designated to be displayed in the second view frustum, such as the second view frustum 620 displayed in FIG. 6B.

At block 520, the PDD, may receive the first and second encoded streams from the server. Upon receiving the two streams, the control circuitry, such as the control circuitry 228 of the PDD, may transmit the second encoded stream to the XR device. The control circuitry, such as the control circuitry 228 of the PDD, may also decode the first encoded stream at block 525. If the PDD has the processing capability, then the functions described in blocks 520-575 and 585-590 may be performed by the PDD. However, if the processing function is being handled by another processing device, such as a set-top box, casting stick, USB stick, a streaming stick, or another type of local console then the functions described in blocks 520-575 and 585-590 may be performed by another processing device that is communicatively connected to the PDD or the display associated with the PDD. In yet another embodiment, if the PDD, processing device, and display may be integrated into one unit, such a smart TV or a mobile phone, then the functions described in blocks 520-575 and 585-590 may be performed by the smart TV. For sake of simplification, the functions described in blocks 520-575 and 585-590 will be referred to as being performed by the PDD. However, any combinations of the processing device being separate or integrated into the PDD or the display are also contemplated and considered to be within the embodiments.

At block 535, the primary image portion of the composite display may be obtained by the PDD. As described earlier, this primary image portion may be any type of content that is designated for display on the display associated with the PDD and within the first viewing frustum.

At block 550, the control circuitry, such as control circuitry 276 of the XR device in FIG. 2, may receive the second encoded stream from the PDD. The control circuitry 276 of the XR device may decode the second encoded stream at block 555 to obtain the enhanced image portion of the composite image at block 560. As described earlier, this enhanced image portion is a virtual portion of the same content as displayed in the primary image portion but with a larger span. For example, if the primary image portion is an image of the Eiffel Tower, the enhanced image portion is the surrounding area of the Eiffel Tower and maintains image continuity from the view shown of the Eiffel Tower on the display associated with the PDD to the view shown in the enhanced image portion. The content of the enhanced image portion may be content presented in the virtual format that is not in the primary image portion.

At block 565, once the enhanced image portion is obtained, control circuitry 276 of the XR device may transmit a message with a display schedule to coordinate simultaneous (i.e., time-synchronized) displays of both the primary and enhanced image portions of the composite image. Since the primary and enhanced image portions collectively form the composite image, a time-synchronized display of both the primary and enhanced image portions would provide the appearance of one single coherent image to the user that is consuming the composite image via the screen of their XR device.

At block 545, the control circuitry 228 of the PDD may receive the message from the XR device having the display schedule. The control circuitry 228 of the PDD may process the instructions included in the message and align the frames of the primary image portion in time with the corresponding frames of the enhanced image portion.

At block 570, the control circuitry 228 of the PDD or the server 220 may determine whether there are any network delays that prevent the synchronizing of the primary and enhanced image portion of the composite image. For example, network delays may be due to traffic congestion, a node in the network being down, or poor network connection. Whatever the reason may be for network delays, when a network delay is determined at block 570, then at blocks 585 and 590, the frames of the primary image portion may be buffered and stored until the rendering of the enhanced image portion display catches up to the primary image portion. The primary image portion is displayed at block 590 once a determination is made that the corresponding frames of the enhanced image portion display have caught up to the primary image portion.

At block 570 (and block 590) when it is time to display the primary image portion on the display associated with the PDD, both the primary image portion at block 570 (or 590) and the enhanced image portion at block 580 may be simultaneously displayed. The simultaneous and synchronized in-time display of the combined image portion, which form the composite image, may provide the appearance of one single image having a large span that extends from the PDD into the virtual space on the display of the XR device. The primary image portion may be displayed on the display associated with the PDD and the enhanced image portion may be displayed at the display of XR device as a virtual overlay.

In another embodiment, as an alternative to blocks 545, and 570, after receiving both first and second encoded streams at block 520, the PDD may decode the frames of the first encoded stream which relate to the primary mage portion and place them into a buffer. The PDD may transmit the second encoded stream that contains frames associated with the enhanced image portion to the XR device. The XR device will decode the second encoded stream. At the time of rendering of the frames associated with the enhanced image portion, a timing value will be sent to the PDD device resulting in the frames relating to the primary image portion from the buffer to be rendered synchronously with frames of the enhanced image portion that are rendered by the XR device.

Although a communications flow between server, PDD and XR device for transmitting and displaying a composite image has been described in relation to FIG. 5, it is only one of several possible embodiments that may be used to display a composite image. In other embodiments, the server may send a single stream to only one of the devices, i.e., the XR device or the PDD, or the server may send two separate streams to both the XR device and the PDD. In yet other embodiments, the server may send a single stream to a third device (e.g., at the home). Some of these embodiments are described further below (not shown in FIG. 5).

In some embodiments, generating for simultaneous display the primary image portion and the enhanced image portion may include the XR device transmitting, to the PDD, one or more messages indicating one or more times at which one or more frames are to be displayed. In other embodiments, the PDD may transmit to the XR device one or more messages indicating one or more times at which one or more frames are to be displayed. Both devices may have access to one or more clocks that are synchronized. The enhanced image portion and primary image portion may have different frames that are linked, such as via timestamping, corresponding frame numbers, etc. When they are linked, such as via timestamping or corresponding frame numbers, one of the devices, such as the XR device, may message the other device, such as the PDD, to render a frame with time stamp that correlates with a timestamp for a matching frame at the XR device. The XR device may also simultaneously render its own frame of the corresponding frame number, with the assumption that the PDD will receive the message and render at approximately the same time.

In yet another embodiment, not shown in FIG. 5, communications flow between server, PDD and XR device for transmitting and displaying a composite image alternative to that depicted in FIG. 5 may include the server sending the two streams directly to the relevant devices. In this embodiment, the server may generate a composite display by first identifying, from the composite display, the primary and enhanced image portions. To do so, the server may encode a first encoded stream carrying the primary image portion and a second encoded stream carrying the second image portion. The server may then transmit to another device, such a set-top box, streaming stick, dongle, or another type of local console that is communicatively coupled to the PDD, the first encoded stream. The server may also transmit to the XR device, the second encoded stream. Various techniques may be used to reduce any latency caused due to the approach described in this embodiment.

In this embodiment, the device communicatively connected to the PDD, such as the set-top box, streaming stick, dongle, or another type of local console that may receive the first encoded stream carrying the primary image portion may (i) decode the first encoded stream to obtain the primary image portion and (ii) store, at a memory, the primary image portion.

The XR device receiving the second encoded stream carrying the enhanced image portion may decode the second encoded stream to obtain the enhanced image portion. The XR device may then, in accordance with one or more time-synchronized clocks, cause simultaneous display, via the PDD and the XR device, of (i) the primary image portion at the display associated with the PDD, and (ii) the enhanced image portion at the display of the XR device.

In yet another embodiment, not shown in FIG. 5, communications flow between server, PDD and XR device for transmitting and displaying a composite image alternative to that depicted in FIG. 5 may include the server sending a single stream to one of the two devices, i.e., the PDD or the XR device. The receiving device may decode the single stream and then split the whole image, i.e., the composite image into two parts, i.e., the primary image portion and the enhanced image portion. The receiving device may then separate the portion relevant to the other device from the composite image. The receiving device may then re-encode the stream with a portion that is relevant to the other device, and then transmit the re-encoded stream with the portion that is relevant to the other device. Each receiving device may render their decoded portion of the composite display such that the rendering of the primary image portion and enhanced image portion is performed synchronously to provide an appearance of one single coherent image. Various techniques may be used to reduce any latency that may be caused using this approach.

In some embodiments, to generate the composite display, the server 591 may encode a first encoded stream carrying the composite display 592, as depicted in FIG. 5B. The server 591 may transmit the first encoded stream to a first device (i.e., the PDD, the display associated with the PDD, or the XR device) 592. The process 594 may include decoding the first encoded stream at the first device to obtain the composite display. Once the first encoded stream is decoded, the primary and enhanced image portions may be identified from the composite display. The first device may then split the composite image into two parts, i.e., the primary image portion and the enhanced image portion. The first device may then retain the portion relevant to them and separate the portion relevant to the other device from the composite image. For example, if the first device is a PDD, then the portion relevant to the PDD would be the primary image portion. Likewise, if the first device is the XR device, then the portion relevant to the XR device would be the enhanced image portion.

The images extracted from the first encoded stream relevant to the other device are then re-encoded by the first device as the second encoded stream. As such, the second encoded stream 595 would only include the image portion not relevant to the first device. For example, if the PDD is the first device, the portion not relevant to the PDD would be the enhanced image portion. The first device would then transmit the second encoded stream to the other device. If the first device is the PDD, then the other device may be the XR device. If the first device is the XR device, then the other device may be the PDD.

The other device 596 may receive the second encoded stream and decode it to obtain the portion relevant to the other device. For example, if the other device is the PDD then the portion relevant to it would be the primary image portion. The first device and the other device may then, in accordance with one or more time-synchronized clocks, cause simultaneous display, of (i) the primary image portion on the display associated with the PDD, and (ii) the enhanced image portion at the XR device. In some embodiments, there may be a possibility that latency may occur based on this approach. As such, various techniques may be used to reduce any such latency. For example, latency may cause a delay of <˜2 ms at the XR device in rendering frames associated with the enhanced image portion. In other words, the rendering at the XR device may lag behind the rendering at the PDD. To accommodate for the delay caused due to latency, the system may introduce a rendering delay for the device that is ahead, e.g., the PDD, such that the device that lags behind, e.g., the XR device, catches up. The amount of rendering delay introduced may be the same as the amount of delay caused due to latency.

In yet another embodiment, not shown in FIG. 5, communications flow between server, PDD and XR device for transmitting and displaying a composite image alternative to that depicted in FIG. 5 may include the server sending a single stream to a third device (e.g., at the home). In this embodiment, the third device may receive and decode the stream. It may then apply processing to split the stream into a PDD stream and XR device stream. It may then perform encoding of PDD stream and the XR device stream while maintaining a common timing value per frame. The third device may then transmit the PDD stream to the PDD and the XR device stream to the XR device. The PDD stream may contain only the primary image portion and the XR device stream may contain only the enhanced image portion. Various techniques may be used to reduce any latency caused due to the approach described in this embodiment. For example, timing of rendering may be adjusted to accommodate for any delays due to latency such that rendering of the primary image portion and enhanced image portion is performed synchronously to provide an appearance of one single coherent image.

The PDD receiving the first encoded stream may decode it to obtain the primary image portion and the XR device receiving the second encoded stream may decode it to obtain the enhanced image portion. The PDD and the XR device may then, in accordance with one or more time-synchronized clocks, cause simultaneous display, of (i) the primary image portion on the display associated with the PDD, and (ii) the enhanced image portion at the display of the XR device. Any latency introduced in this embodiment may be adjusted using various techniques. For example, timing of rendering may be adjusted to accommodate for any delays due to latency such that rendering of the primary image portion and enhanced image portion is performed synchronously to provide an appearance of one single coherent image.

In yet another embodiment, not shown in FIG. 5, a physical display may be communicatively coupled to the PDD. In this embodiment, the PDD may be a local console such as a gaming console, a set-top box, or some other type of processing device and the physical display may be a monitor, a TV, or any other type of display device. In an embodiment, the PDD generates the primary image portion and the enhanced image portion.

In an embodiment, the PDD may generate the composite image, and the PDD may identify the primary and enhanced image portions of the composite image. The PDD may separate the primary image portion from the composite image and buffer the primary image portion of the stream to the physical display for rendering.

After the enhanced image portion has been generated or identified, the PDD may encode the enhanced image portion, as an encoded stream, carrying only the enhanced image portion. The encoded stream may be transmitted from the PDD to the XR device. The XR device receiving the encoded stream may decode it to obtain the enhanced image portion. The display communicatively coupled to the PDD and the XR device may then, in accordance with one or more time-synchronized clocks, cause simultaneous display, of (i) the primary image portion on the physical display communicatively coupled to the PDD, and (ii) the enhanced image portion at the display of the XR device. Any latency introduced in this embodiment may be adjusted. For example, timing of rendering may be adjusted such that a device that lags behind may catch up to a device that is ahead such that rendering of the primary image portion and enhanced image portion is performed synchronously to provide an appearance of one single coherent image.

FIG. 6A is an example of a living room that includes a PDD and FIG. 6B is an example of different portions of a composite image 607, in accordance with some embodiments of the disclosure. As depicted in FIG. 6A, John's living room includes a PDD 602 (a TV in this embodiment), a three-seater sofa 601, a tall standing lamp 605, a wall clock 604, and an armchair 603.

Referring to FIG. 6B, John is located in his living room while wearing an XR device 606. The XR device FOV 610 spans the region of space visible to John by way of the display of the XR device 606. For the sake of describing the concept, the scene observed by John through the XR device 606 includes a portion of the depicted living room. In an embodiment, the XR device FOV 610 may have a horizontal span of somewhere between 100-150°. In some instances, the XR device FOV 610 may be less than 100° or greater than 150°, depending on the optics utilized (e.g., fisheye optics may enable a span of) 180°.

The composite image 607 displayed in FIG. 6B includes the primary image portion 650 and the enhanced image portion 640. The enhanced image portion 640 of the composite image 607 is spatially anchored to the PDD 602. For example, 3D coordinates for one or more of the four corners of the primary image portion 650 may be determined. The four corners of the interior “cut out” rectangle of the enhanced image portion 640 may be assigned these 3D coordinates (or may be assigned nearby 3D coordinates). As such, even if the scene depicted or presented by the XR device 606 changes (e.g., based on the user changing position or orientation), the position, orientation, and size of the composite image 607 may remain static relative to the living room environment because it remains anchored to the PDD 602. In other embodiments, such as in FIG. 7, when the user orients away from the PDD 602, some or all of the composite image 607 may not be presented by the XR device 606.

Returning to FIG. 6B, a composite image 607 depicts a ski slope area with two children on a sled 615, a large Christmas tree 616, and another child building a snowman 617. In the shown embodiment, the composite image 607 has a second viewing frustum 620, and the entirety of composite image 607 falls within the XR device FOV 610 and is therefore presented by the XR device 606.

The enhanced image portion 640 of the composite display may be projected directly into the eye (e.g., the retina) of John, who is wearing the XR device 606. In some instances, the enhanced image portion 640 is projected onto one or more surfaces of the XR device 606 for display to John.

The second viewing frustum 620, as depicted, is larger in size than the first viewing frustum 630 and extends beyond the span of the content displayed in the first viewing frustum 630.

The primary image portion 650 depicts a volume of space in a depicted scene; this volume of space is the first viewing frustum 630. When the span of the primary image portion 650 is extended virtually into the extended display as an enhanced image portion 640, the enhanced image portion 640 may be outside the primary image portion 650 but may have image continuity with the primary image portion 650.

Staying with FIG. 6B, the primary image portion 650 and the enhanced image portion 640 depict a continuous image of a ski slope (i.e., the composite image 607). The primary image portion 650 displays, among other objects, the two children on a sled 615 and a portion of the large Christmas tree 616. The enhanced image position, which extends the span of the primary image portion, as depicted, shows the remaining portion of the large Christmas tree 616 and another child building a snowman 617. As it can be seen, at least based on portions of the large Christmas tree being displayed in the primary and enhanced image portions, that collectively, the composite display maintains image continuity from the primary image portion to the enhanced image portion. In some instances, the composite image 607 maintains a degree of color continuity from the primary image portion 650 to the enhanced image portion 640 to provide a feel of one continuous image having a larger frustum or volume of depicted space when compared to that of the primary image portion 650.

The size and frustum of the enhanced image portion may change over time (e.g., as a content item is played). The changes may be based on what the designers and developers of the content have designed, as well as what changes can be accommodated based on system parameters, such as rendering load, encoding-decoding load, etc. For example, the size of the enhanced image portion may vary frame by frame or segment by segment. This may be due to the changing size of the enhanced image or changing perspective, or both, based on the different camera modes used. Similarly, in one frame, the enhanced image portion 640 may depict a volume from the perspective of a “normal” camera or lens. In a second frame, the enhanced image portion may depict a volume from a wider perspective.

FIG. 7 is an example of pixel stream length determined based on size of virtual extension (enhanced image portion) that provides a larger span of content, in accordance with some embodiments of the disclosure.

The composite image includes two portions, a primary image portion and an enhanced image portion. The enhanced image portion is related to the content displayed in the primary image portion and is used to provide a larger span for the same content displayed in the primary image portion. The larger span is provided by virtually displaying the enhanced image portion at the display of the XR device and ensuring image and color continuity with the primary image portion. The size and direction of this enhanced image portion can vary from frame to frame depending on the programmer's intent and system parameters such as rendering load, encode-decode load, etc. (i.e., on how much additional content they desire to show).

Although the size and direction of the virtual extension of the enhanced image portion may vary, including in a horizontal and/or vertical direction, an extension in only the horizontal direction of the enhanced image portion is given as an example for sake of simplicity and explanation in FIG. 7. In this embodiment, the primary screen plane 710, such as a TV screen on which the primary image portion is to be displayed, has a height/length 1 (not shown), and a width x.

The enhanced image portion is designated to be added horizontally on both sides of the primary image portion displayed on the primary screen plane (also referred to herein as the display associated with the PDD). Once added, i.e., after the virtual extension in the horizontal dimension, the screen acquires a total width Y 720. The length of the perpendicular between the primary screen plane 710 and the XR device 730, as shown, is d 740.

In this embodiment, the width of the enhanced image portion on the left side of primary screen plane 710 may be calculated as:

$$w 1 = {Y}_{1} - {x}_{1} = \frac{d}{tan γ} \frac{d}{tan α}$$

Similarly, in this embodiment, the width of the enhanced image portion on the right side of primary screen plane 710 may be calculated as:

$${w}_{r} = {Y}_{2} - {x}_{2} = \frac{d}{tan δ} \frac{d}{tan β}$$

The angles, α, β, γ, δ, may be obtained from the angles subtended by the main and desired virtual displays at the XR glasses.

Accordingly, the total pixel stream may be calculated as: length×width×resolution (length multiplied by width multiplied by resolution), i.e., p=1*(w 1+wᵣ)*R.

In this embodiment, the resolution R may be the maximum resolution supported by the XR device. After the XR device receives the stream in this resolution, the XR device may apply a spatial transform to present the enhanced image portion in a 2D or 3D format. The enhanced image portion would be spatially anchored around the primary screen plane at the appropriate depth and orientation.

Although the maximum resolution supported by XR device may be more than that of the primary image portion displayed on the primary screen plane (i.e., display associated with the PDD), such as a TV or computer monitor, the pixels per degree presented in the near-eye display of the XR device may be lower. Accordingly, in one embodiment, the enhanced image portion for extending the span of the primary image portion may be sent at maximum possible resolution. However, the maximum resolution possible may be limited by the type and brand of XR device and maximum resolution capabilities of such device.

Once the pixel stream length and width are determined at server 510, a rendering-encoding unit may be used to set up the primary and enhanced image portions of the composite image to be displayed on the display associated with the PDD and the display of the XR device. The streaming across the two devices (display associated with the PDD and the display of the XR device) may be synchronized in time such that the XR device displays the enhanced image portion for the corresponding frame number as the primary image portion. For example, each corresponding frame may be given a same frame number, or some other numbering system may be used to identify the corresponding frames for a scene for the primary and enhanced image portions.

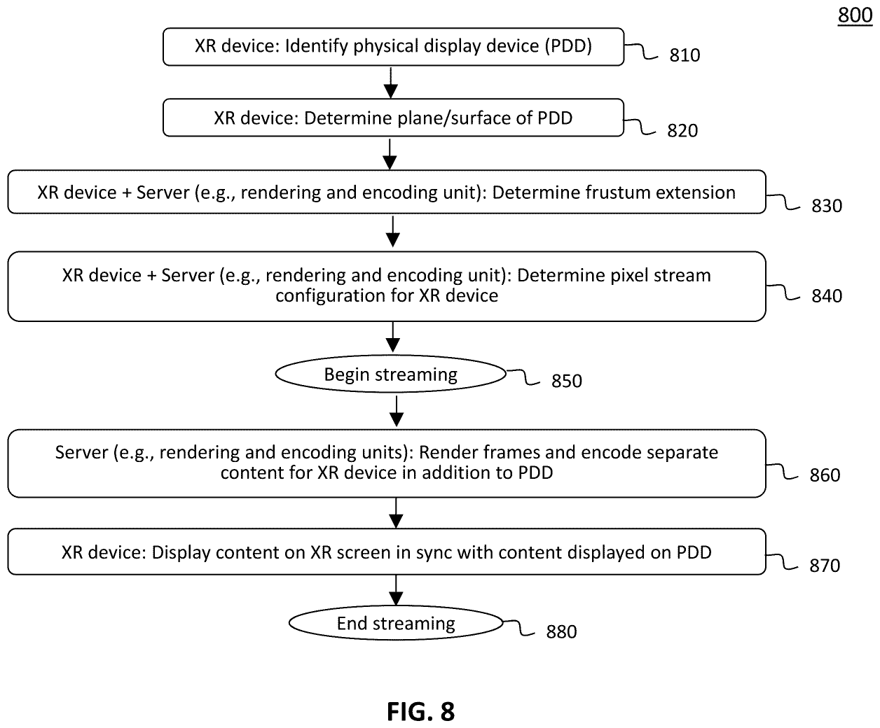

FIG. 8 is a flowchart of a process 800 for determining the pixel stream configuration for the example provided in FIG. 7, in accordance with some embodiments of the disclosure. Although FIG. 8 is directed at the example provided in FIG. 7 for sake of simplification and explanation, the process 800 is not so limited and may be applied to any enhanced image portion extension to determine the pixel stream configuration.

The process 800 may be implemented, in whole or in part, by systems or devices such as those shown in FIGS. 2-3. One or more actions of the process 800 may be incorporated into or combined with one or more actions of any other process or embodiments described herein. The process 800 may be saved to a memory or storage (e.g., any one of those depicted in FIGS. 2-3) as one or more instructions or routines that may be executed by a corresponding device or system to implement the process 800.

In some embodiments, at block 810, the XR device, such as via control circuitry 276 depicted in FIG. 2, may identify a PDD, or more specifically a display associated with the PDD in the XR device FOV. In some embodiments, the PDD may include a display and have processing capability, in another embodiment, the PDD may be separate device that is associated with a display, and in yet other embodiments, a processing device may be communicatively connected to the PDD or directly to the display device. The identification in block 810 may refer to the display portion of the PDD or processing device in any of the embodiments described above.

The XR device may utilize its outward-facing camera to scan objects in XR device FOV and process the objects using image recognition techniques to determine whether a display associated with a PDD, such as the TV, laptop, or screen of a projector, is within the FOV of the XR device. If such as display associated with a PDD has been detected, then that may be used as a trigger to determine, at block 820, the plane/surface of the PDD if integrated with the display, or the display, if the display is separate from the PDD.

At block 830, the rendering and encoding units associated with the XR device and the server may determine the frustum extension. In other words, they may determine the direction and size of the second viewing frustum as depicted as 620 in FIG. 6 and VF2 720 in FIG. 7. The size of this second viewing frustum may be determined by the programmer based on any one or more of type of application (such as gaming, computer application, OTT content consumption, etc.), rendering load on the system, user comfort, and resolution of image in the primary image portion.

At block 840, the XR device and the server, such as the XR device 270 and/or server 202 in FIG. 2, may determine the pixel stream configuration. To determine the pixel stream configuration, the XR device 270 and/or server 202 may determine the height/length 1 and width x of the first viewing frustum. The XR device 270 and/or server 202 may then determine the extent of the enhanced image portion that is to be virtually displayed at the display of the XR device. For example, if the extension is to be only in a horizontal direction in the same plane as the primary image portion, then the XR device 270 and/or server 202 may determine a total width Y 720, i.e., the total horizontal size of the composite image that would include the primary and the enhanced image portions. The XR device 270 and/or server 202 may also determine the length of the perpendicular between the display associated with the PDD and the XR device, such as shown as d 740 in FIG. 7.

The XR device 270 and/or server 202 may calculate the width of the enhanced image portion on the left side of first viewing frustum as shown in FIG. 7 as:

$$w 1 = {Y}_{1} - {x}_{1} = \frac{d}{tan γ} \frac{d}{tan α}$$

Similarly, in this embodiment, the XR device 270 and/or server 202 may calculate the width of the enhanced image portion on the right side of the first viewing frustum as shown in FIG. 7 as:

$${w}_{r} = {Y}_{2} - {x}_{2} = \frac{d}{tan δ} \frac{d}{tan β}$$

The angles, α, β, γ, δ, may be obtained from the angles subtended by the primary image portion and the enhanced image portion at the display of the XR device.

Accordingly, the total pixel stream may be calculated as: length×width×resolution (length multiplied by width multiplied by resolution), i.e., p=1*(w1+wᵣ)*R.

In this embodiment, the resolution R may be the maximum resolution supported by the XR device. After the XR device receives the stream in this resolution, the XR device may apply a spatial transform to present the enhanced image portion in a 2D or 3D format. The enhanced image portion would be spatially anchored around the primary screen plane at the appropriate depth and orientation.

Once the pixel stream length and width are determined, the server may, at block 850, may begin streaming an encoded stream for the primary and enhanced image portions of the composite image. The process may include, as depicted at blocks 860-880, rendering frames and separately encoding content for the XR device in addition to the PDD at block 860 and displaying the primary image portion synchronized with the enhanced image portion at block 870. Details relating to the process of streaming the primary and enhanced image portions of the composite image, referred to as first and second encoded streams, decoding the encoded streams, and displaying the primary image portion on a display associated with the PDD in a see-through mode; and displaying the enhanced image portion at the XR device simultaneously in a time-synchronized manner are described above in relation to FIG. 5. The displaying of the enhanced image is performed by projecting directly into the eye of the user where the display of the XR device is an image perceived by the user when viewing this projected image.

FIG. 9 is a flowchart of a process for calibrating the enhanced image portion of the composite image with the primary image portion of the composite image and FIG. 10 shows an example of applying the calibration process of FIG. 9, in accordance with some embodiments of the disclosure.

The process 900 may be implemented, in whole or in part, by systems or devices such as those shown in FIGS. 2-3. One or more actions of the process 900 may be incorporated into or combined with one or more actions of any other process or embodiments described herein. The process 900 may be saved to a memory or storage (e.g., any one of those depicted in FIGS. 2-3) as one or more instructions or routines that may be executed by a corresponding device or system to implement the process 900.

Process 900, in some embodiments, may be used to initially calibrate the enhanced image portion with the primary image portion. Factors relating to the size of the display associated with the PDD in which primary image portion is displayed and the XR device's FOV may be considered for the initial calibration.

At block 910, a request may be made to calibrate the enhanced image portion of the composite image for rendering. The request may be made by the user, the XR device, the server, the PDD, or the processing device or display associated with the PDD.

In some embodiments, at block 920, the XR device may send a request to the PDD to initiate the calibration. Upon receiving the request, the PDD, at block 930 may display a calibration display (e.g., calibration pattern) with a border of PDD identifier and center of display associated with the PDD identifier. One example of the calibration pattern 1030 is depicted in FIG. 10 and one example of the identifier for the center of display associated with PDD, such as a red circle indicator 1040, is also depicted in FIG. 10. Based on the calibration pattern 1030, the XR device may identify the border markers 1010 and the center mark 1040 of the display associated with the PDD.

At block 940, the PDD may signal the XR device for user calibration. Upon receiving the signal, the XR device, at block 950, may direct the user to move in front of the display associated with the PDD and look at the center calibration marker 1040. At block 950, the user may also be directed to move forward or backward while looking directly at the center calibration marker 1040 in order to determine the calibration.

At block 960, the XR device may analyze the calibration image and direct the user to move towards or away from the PDD to calculate optimal distance for maximum view of the second view frustum based on XR device's display capabilities.

At block 970, the XR device may determine if the user's position is optimized. If not, then the process may move back to block 950 and repeat until the user's position is optimized.

Once the calibration is complete (“Yes” at block 970), at block 980, the spatial coordinate boundaries of the physical display will be saved and anchored in the XR device. An enhanced image portion will be created around and anchored at the spatial coordinates calculated from the calibration process. The over-rendered pixel rendering area will be based on a calculation of these measured spatial coordinates. The GPU will render the pixels to be displayed in the primary image portion. The GPU will render the enhanced image portion by rendering only pixels beyond the primary image portion with no (duplicative) rendering taking place for the pixel coordinates covering the primary image portion and then, at block 990, disable the calibration mode.

If the user moves closer to the PDD from the initial calibration, pixels will move out of view of the headset. However, since this is a virtual display anchored at the same spatial coordinates in the calibration process, the over rendered portion that extends beyond the display's FOV will no longer be viewed by the user. The user can reposition their head pose to view the rendered pixels that become outside the view of the viewport. On the other hand, if the user moves too far away, the extended over rendering will no longer fill the complete FOV of the XR device. The over rendered display behaves the same as the user moving closer or farther away from the PDD since the physical anchoring on the z axis is the same in the 3D space between the PDD and the XR device.

FIG. 11 is an example of side-by-side comparison of primary image portion, enhanced image portion, and the two together as composite image, including the calibration of the enhanced image portion with the primary image portion, in accordance with some embodiments of the disclosure.

In some embodiments, a PDD rendering 1110 by itself is displayed. This would be the rendering for the primary image portion of the composite image within the first view frustum. The primary image content may be received by the PDD from a server. The primary image portion may be received in a content stream, such as the first content stream at block 520 in FIG. 5. The control circuitry 228 of the PDD may decode the first encoded stream and obtain the primary image portion from the stream.

In some embodiments, a rendering of only the enhanced image portion 1120 by itself is displayed. This enhanced image portion of the composite image is rendered within the second view frustum. The enhanced image portion may be received by the XR device from the PDD or directly from the server in a content stream, such as the second content stream at block 550 in FIG. 5. The control circuitry 276 of the XR device may decode the second encoded stream and obtain the enhanced image portion from the second stream.

In some embodiments, a rendering of composite image 1130, which comprises both the primary and the enhanced image portions, is displayed. This composite image is rendered by the primary image portion being rendered on a display associated with the PDD and the enhanced image portion of the composite image is rendered at the display of the XR device. Both portions are rendered simultaneously and synchronized in time to give the appearance of a single composite image that has image and color continuity from the PDD to the virtual space, i.e., the overlay of the enhanced image portion at the display of the XR device.

FIG. 12 is a flowchart of a process 1200 for color-matching the enhanced image portion of the composite image with the primary image portion of the composite image, in accordance with some embodiments of the disclosure.

The process 1200 may be implemented, in whole or in part, by systems or devices such as those shown in FIGS. 2-3. One or more actions of the process 1200 may be incorporated into or combined with one or more actions of any other process or embodiments described herein. The process 1200 may be saved to a memory or storage (e.g., any one of those depicted in FIGS. 2-3) as one or more instructions or routines that may be executed by a corresponding device or system to implement the process 1200.

As described earlier, the composite image is comprised of both the primary and the enhanced image portion. Each portion may be transmitted by the server in separate content streams, such as the first and second content stream. The primary image portion is decoded by the PDD, and the enhanced image portion is decoded by the XR device. Both the primary and enhanced image portions are displayed at the same time and with image continuity to provide the appearance of the composite image being a single continuous image.

To provide the appearance of the composite image being a single coherent image, colors in both primary and enhanced image portions must also be matched. In some embodiments, the matching may be to the extent possible, since the same color values may appear marginally different on different displays (e.g., PDD and XR device). To do so, the XR device, or a server associated with the XR device, may execute a color matching process to ensure that images displayed in the primary image portion and enhanced image portion, as perceived, have color continuity.

In some embodiments, the color-matching process may include measuring observed average pixel intensity of a region of a primary image portion from series or primary image portions, as depicted at block 1210. This would mean observing pixel intensities across multiple frames as they are displayed in the primary image portion. These pixel intensities may be transmitted in any formats such as RGB, YUV, etc.

At block 1220, the system may compare with average source pixel intensity of the region in the PDD to derive offset. The system may calculate the average intensity of pixels for the primary image portion from a decoded source stream intended for display at the PDD. The system may then calculate any offsets between the average intensities of what is observed in the primary image portion and what is observed via the XR device. The difference of the two average intensity values of what is displayed in the primary image portion and what is observed via the XR device represents the offset described.

In one embodiment, the composite image is encoded as a single stream and sent to the XR device so that it can decode the entire composite image and calculate the offset by measuring the difference between the pixel values representing the primary image in the source stream and the observed primary image.

In another embodiment, the first encoded stream representing the primary image is sent for a short time to the XR device, and/or sent periodically to the XR device, so it may calculate the offset.

In another embodiment, the XR device measures and transmits the observed average pixel intensity of the primary image at the PDD to the server. The server calculates the offset. The server then applies the offset prior to encoding and transmitting the second source stream representing the enhanced image to the XR device.

At block 1230, the offset may be applied to the enhanced image portion of the display. More specifically, the offset determination may be applied to pixel intensities from the source stream for the enhanced image portion at the renderer of the XR device. The application of the offset may be applied either during rendering by the server, or at the XR device after decoding the second stream prior to displaying. Accordingly, dissonance from unmatched colors between the primary image portion and enhanced image portion may be reduced by applying the color matching process 1200.

Accordingly, the offset determined may be applied to the regions 1240 as follows:

$$Yoffset = Yavg {source}^{-} Yavg image$$

$$Uoffset = Uavg {source}^{-} Uavg image$$

$$Voffset = V avg {source}^{-} Vavg image$$

At the XR device, the renderer applies:

$$Yi = Yi , received + Yoffset$$

$$Ui = Ui , received + Uoffset$$

$$Vi = Vi , received + Voffset$$

Where Yi, received is the received value of luminance of i′th pixel, and Yi is the adjusted value.

In some embodiments, the offset is modeled using a polynomial or step-wise other mathematical function rather than as a constant. Although polynomial or step-wise other mathematical function is used, the embodiments are not so limited and other types of models and functions may also be used.

In some embodiments the technique is applied separately to different regions of the main display. For example, as depicted at 1240, the technique is applied separately to four different regions, regions 1-4. In other embodiments, the technique may be applied separately to 16 regions or some other selected number.

In some embodiments, the image is low-pass filtered to remove drastic transitions across regions. In some embodiments, each region is not discrete, rather a weight is assigned to each pixel. The weight decreases monotonically as the distance between the pixel and the geometric center of the region increases. The offset is calculated using a weighted average.

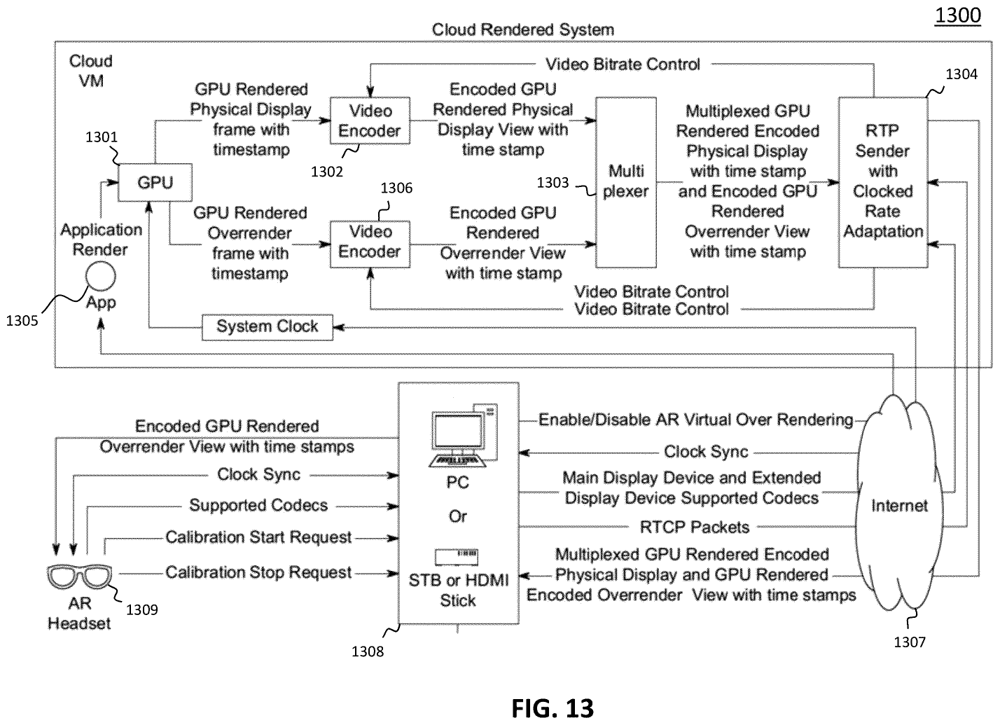

FIG. 13 is an example of a process 1300 of using a cloud rendering system for providing a composite image, in accordance with some embodiments of the disclosure.

The process 1300 may be implemented, in whole or in part, by systems or devices such as those shown in FIGS. 2-3. One or more actions of the process 1300 may be incorporated into or combined with one or more actions of any other process or embodiments described herein. The process 1300 may be saved to a memory or storage (e.g., any one of those depicted in FIGS. 2-3) as one or more instructions or routines that may be executed by a corresponding device or system to implement the process 1300.

In some embodiments, FIG. 13 depicts an architecture for a cloud-based rendering solution in which the application runs in the cloud and sends images, such as primary and enhanced image portions to render to the GPU 1301. If rendering for the enhanced image portion is disabled, also referred to as over rendering being disabled, the GPU 1301 will only render the primary image portion with frame timestamp.

The rendering may include sending the primary image portion with frame timestamp to an encoder 1302 optimized for the best codec supported by the client device, such as the PDD. The encoded stream, such as the first encoded stream in FIG. 5, is sent to a multiplexer 1303 and wrapped in an appropriate container for transport over the network 1307. For low latency, this example enablement leverages RTP (Real-Time Transport Protocol) 1304 which is also able to adjust for changes in the network fluctuation. Based on calculations from the RTCP (Real-Time Control Protocol), the video bit rate may be adjusted based on changing network conditions to ensure the network QoS can deliver the encoded video.

In some embodiments, an application 1305 may receive a request to enable the enhanced image portion of the composite image. Since the enhanced image portion is to be virtually overlayed at the display of an XR device, a new encoder may be instantiated for the XR device. The new encoder may then be optimized with the best codec available for the XR device.

In some embodiments, the clocks will be synchronized between a hosting the application, the PDD 308, and the XR device 1309. The application may render the primary image portion of the composite image with a time stamp for each frame of the primary image portion. The pixels for the enhanced image portion may be rendered with time stamp and sent to the over render encoder or the enhanced image portion encoder that was instantiated at the XR device. The content stream in which the encoded enhanced image portion is included, such as the second content stream of FIG. 5, the stream may be sent to the multiplexer 1303 and added to the streams to be sent to the XR device 1309.

In some embodiments, the multiplexer 1303 may multiplex the stream carrying the primary image portion, such as the first encoded stream of FIG. 5, and the stream carrying the enhanced image portion, such as the second encoded stream of FIG. 5. The multiplexed streams may then be transmitted via an RTP sender 1304 to the client device, such as the stream with primary image portion to the PDD 1308 and the stream with the enhanced image portion to the XR device 1309. The client device's RTP receiver receives a multiplexed stream packet. The receiver will respond to the RTP sender 1304 with a response RTCP packet. This allows the system to measure the network QoS and based on the changing network QoS adjust the encoding bit rate.

In another embodiment, a different metric bandwidth management technique may be applied for both the stream carrying the primary image portion and the stream carrying the enhanced image portion. In this technique, the streams may use a Self-Clocked Rate Adaptation.

In some embodiments, a weighting system may be used to determine bitrates for the primary and enhanced image portion of the composite display. In some embodiments, the PDD 1308 may be provided a higher video encoding bitrate than the XR device 1309. The enhanced image portion rendered on the XR device's display in a majority of the time may be in the peripheral vision and the display associated with the PDD 1308 may be inside of the central field of vision. For example, the stream carrying the primary image portion may receive a weight of 2.0 while the stream carrying the enhanced image portion may receive a weight of 1.2 in bandwidth adjustment. In the case of a less than desirable network QoS condition, the primary image portion may receive the higher video quality.

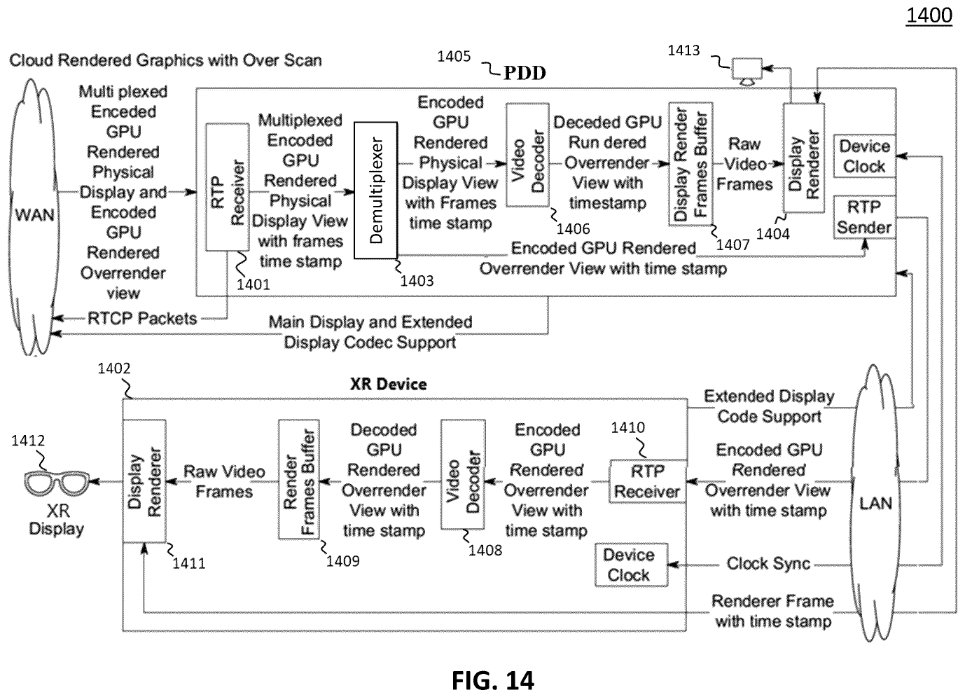

FIG. 14 is an example of a process 1400 for rendering on a client side (PDD or XR device) for providing a composite image, in accordance with some embodiments of the disclosure.

The process 1400 may be implemented, in whole or in part, by systems or devices such as those shown in FIGS. 2-3. One or more actions of the process 1400 may be incorporated into or combined with one or more actions of any other process or embodiments described herein. The process 1400 may be saved to a memory or storage (e.g., any one of those depicted in FIGS. 2-3) as one or more instructions or routines that may be executed by a corresponding device or system to implement the process 1400.

In some embodiments, packets are received by an RTP receiver 1401 associated with the client side, such as the RTP receiver 1401 for the PDD 1405 and/or the XR device 1402. The packets received from the RTP receiver 1401 are sent to the demultiplexer 1403 which demultiplexes the encoded streams, such as the first and second encoded stream described in relation to FIG. 5. The demultiplexing of the encoded streams is performed to generate encoded video streams with frame time stamps.

In the case of a single stream, it is decoded and sent directly to the display render 1404 of the display 1413 of the PDD 1405. If there are two video streams multiplexed, the stream carrying the primary image portion is sent to the video decoder 1406 associated with the PDD 1405. The primary image portion is decoded and the raw video frames with timestamps are sent to the PDD device's frames buffer 1407 where they are cached until a render frame with timestamp is received from the XR device 1402. Likewise, the stream carrying the enhanced image portion is sent to the video decoder 1408 associated with the XR device 1402. The enhanced image portion is decoded and the raw video frames with timestamps are sent to the XR device's frames buffer 1409 where they are cached until a render frame with timestamp is received from the XR device 1402.

Once a frame request is received with a frame timestamp from the XR device 1402, the PDD 1405 will render the proper frame matching the timestamp. In other words, the PDD 1405 will render a frame of the primary image portion that corresponds to the matching frame of the enhanced image portion from the XR device 1402 at the same time, i.e., based on the timestamp, such that together when both corresponding frames are displayed on their respective device, the provide the appearance of one composite image, i.e., a single coherent image.

The demultiplexed enhanced image portion frames are sent in a low latency RTP to the RTP receiver 1410 on the XR device 1402. The RTP receiver 1410 sends the encoded GPU rendered enhanced image portion with timestamp to the XR device's video decoder 1408. The video decoder 1408 decodes the video frame and sends the raw decoded video frames to the render frames buffer 1409. If the XR device 1402 is not waiting for a notification to render a frame, the frame is immediately sent to the display renderer 1411. The XR device's display renderer 1411 sends a render frame request for a frame with the timestamp for displaying it on the display 1412 of the XR device 1402. Based on such rendering, both the primary and enhanced image portions are rendered at the same time and synchronized in time to provide the appearance of one continuous image.

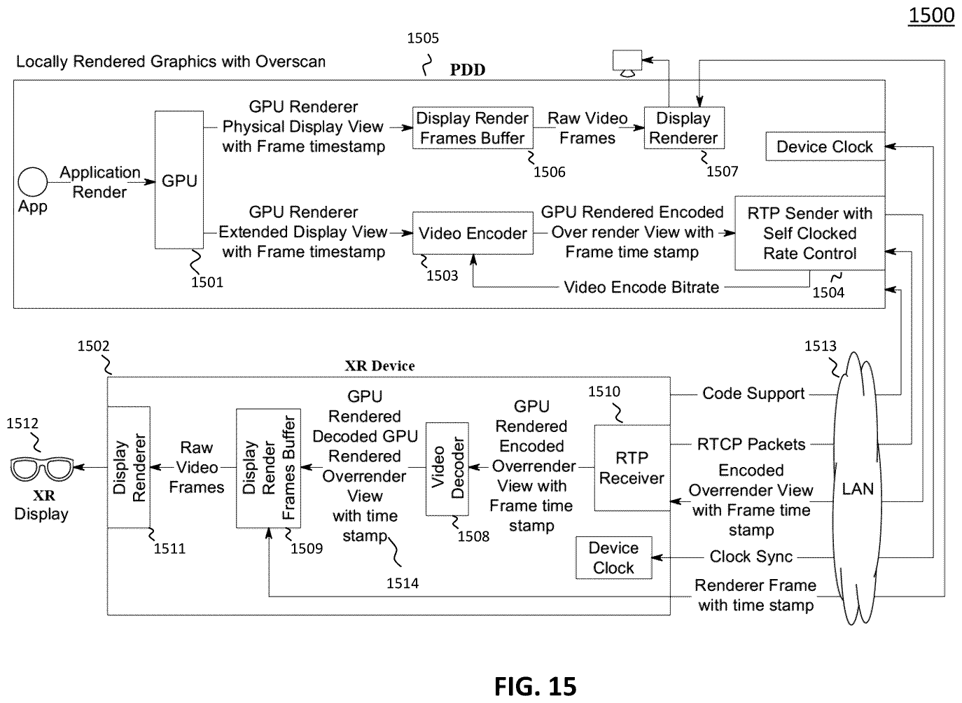

FIG. 15 is an example of a process 1500 for locally rendering graphics with an over scan for providing a composite image, in accordance with some embodiments of the disclosure. The process 1500 may be implemented, in whole or in part, by systems or devices such as those shown in FIGS. 2-3 One or more actions of the process 1500 may be incorporated into or combined with one or more actions of any other process or embodiments described herein. The process 1500 may be saved to a memory or storage (e.g., any one of those depicted in FIGS. 2-3) as one or more instructions or routines that may be executed by a corresponding device or system to implement the process 1500.

A PDD 1505 associated with a local rendering system is demonstrated in FIG. 15. The architecture depicted, in some embodiments, does not allow for any changes on the XR device 1502. For the PDD 1505, the application runs locally on the PDD. The GPU 1501 produces GPU rendered frames for the primary image portion including a frame time stamp. These Raw Video Frames are cached in a Display Render Frames Buffer 1506.

The GPU Rendered Extended Display View with Frame Time Stamp is sent to a video encoder 1503 which is configured to the optimal codec supported by the XR device's decoder 1508. The video encoder 1503 encodes the GPU Rendered enhanced image portion with Frame Time Stamp and sends the encoded frame to the RTP sender 1504. The RTP sender 1504 transports the frame packets over the LAN 1513 to the XR device's RTP receiver 1510. In this embodiment, the PDD 1505 is the source of the LAN 1513. Since the source is the multiplexed video streams, the self-clocked rate control can be implemented for adjustments in QoS over the LAN 1513. In the cloud case, this function is not performed at the XR device 1502. When an enhanced video packet for the GPU Rendered Encoded Overrender View with Frame time stamp is received by the RTP Receiver 1510, the RTP Receiver 1510 will respond with an RTCP packet to notify the RTP sender the packet was received. This allows for the bitrate adjustments to be made based on fluctuations in bandwidth over the LAN. The received video packets for the GPU Rendered Encoded Overrender View with Frame time stamp are sent to the Video Decoder 1508 from the RTP receiver 1510. The Video Decoder 1508 decodes a frame of the GPU Rendered Encoded Overrender View with Frame time stamp and sends the Decoded GPU Rendered Overrender View with Frame time stamp 1514, to the Display render Framed Buffer. Based on such rendering, both the primary and enhanced image portions are rendered at the same time and synchronized in time to provide the appearance of one continuous image.

It will be apparent to those of ordinary skill in the art that methods involved in the above-described embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow and their equivalents are meant to set bounds with respect to the claimed techniques. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying a content item to be displayed at a physical display associated with a physical display device (PDD) according to a first viewing frustum;
receiving a request to provide, at an XR device, a composite image of the content item that spans across a second viewing frustum, wherein the second viewing frustum is larger in size than the first viewing frustum and includes the first viewing frustum;
in response to the receiving of the request to provide the composite image of the content item:
determining a primary image portion of the composite image to be displayed at the physical display associated with the PDD, the primary image portion spanning a first viewing frustum; and
determining an enhanced image portion of the composite image that corresponds to the primary image portion and that is to be displayed virtually within the second viewing frustum and outside the first viewing frustum, wherein the enhanced image portion maintains image continuity with the primary image portion; and
providing, at a display of the XR device, the composite image including the primary image portion and enhanced image portion of the content item, including:
displaying as a see-through at the display of the XR device, the primary image portion that is displayed on the physical display associated with the PDD, wherein the see-through allows viewing the primary image portion via the display of the XR device; and
generating for display, at the display of the XR device, the enhanced image portion of the composite image such that the displaying of the enhanced image portion is time-synchronized with the display of the primary image portion and such that the enhanced image portion is spatially anchored to the primary image portion.

2. The method of claim 1, wherein the composite image occupies only a portion of the display of the XR device and the display of the XR device allows viewability of an entirety of a field of view (FOV) from the XR device.

3. The method of claim 1, wherein providing, at the display of the XR device, the composite image further comprises:
generating, at a server, the composite image;
identifying, from the composite image, the primary and enhanced image portions; and
encoding, at the server, a first encoded stream carrying the primary image portion and a second encoded stream carrying the enhanced image portion.

4. The method of claim 3, further comprising:
transmitting, from the server to the PDD, the first and second encoded streams;
receiving, at the PDD, the first and second encoded streams; and
at the PDD:
(i) decoding the first encoded stream to obtain the primary image portion
(ii) storing, at a memory, the primary image portion; and
(iii) transmitting, to the XR device, the second encoded stream;
decoding, at the XR device, the second encoded stream to obtain the enhanced image portion; and
in accordance with one or more time-synchronized clocks, causing simultaneous display, via the PDD and the XR device, of (i) the primary image portion at the physical display, and (ii) the enhanced image portion at the display of the XR device.

5. (canceled)

6. The method of claim 1, wherein providing, at the display of the XR device, the composite image further comprises:
generating, at a server, the composite image;
identifying, from the composite image, the primary and enhanced image portions;
encoding, at the server, a first encoded stream carrying the primary image portion and a second encoded stream carrying the second content portion;
transmitting, from the server to a PDD, the first encoded stream;
transmitting, from the server to the XR device, the second encoded stream;
at the PDD:
(i) decoding the first encoded stream to obtain the primary image portion; and
(ii) storing, at a memory, the primary image portion;
decoding, at the XR device, the second encoded stream to obtain the enhanced image portion; and
in accordance with one or more time-synchronized clocks, causing simultaneous display, via the PDD and the XR device, of (i) the primary image portion at the physical display, and (ii) the enhanced image portion at the display of the XR device.

7. The method of claim 1, wherein providing, at the display of the XR device, the composite image further comprises:
generating, at a server, the composite image;
encoding, at the server, a given encoded stream carrying the composite image;
transmitting, at the server, the given encoded stream;
receiving the given encoded stream at a first device, the first device selected from one of the XR device or the PDD;
decoding, at the first device, the first encoded stream to obtain the composite image;
identifying, from the composite image, the primary and enhanced image portions;
encoding, at the first device, a particular encoded stream carrying the primary or enhanced image portion;
transmitting, at the first device, the particular encoded stream;
receiving the particular encoded stream at a second device, the second device being the one of the XR device or the PDD that was not selected as the first device;
decoding, at the second device, the particular encoded stream to obtain the primary or enhanced image portion; and
in accordance with one or more time-synchronized clocks, causing simultaneous display, via the PDD and the XR device, of (i) the primary image portion at the physical display, and (ii) the enhanced image portion at the display of the XR device.

8. The method of claim 1, wherein providing, at the display of the XR device, the composite image further comprises:
generating, at a server, the composite image;
encoding, at the server, a given encoded stream carrying the composite image;
transmitting, at the server, the given encoded stream;
receiving, at a third device, the given encoded stream;
decoding, at the third device, the given encoded stream to obtain the composite image;
identifying, from the composite image, the primary and enhanced image portions;
encoding, at the third device, a first encoded stream carrying the primary image portion and a second encoded stream carrying the enhanced image portion;
transmitting, at the third device, the first and second encoded streams;
receiving the first encoded stream at the PDD and the second encoded stream at the XR device;
decoding, at the PDD and the XR device, the first and second encoded streams to obtain the primary and enhanced image portions; and
in accordance with one or more time-synchronized clocks, causing simultaneous display, via the PDD and the XR device, of (i) the primary image portion at the physical display, and (ii) the enhanced image portion at the display of the XR device.

9. The method of claim 1, wherein the physical display is communicatively coupled to the PDD and wherein providing, at the display of the XR device, the composite image further comprises:
generating, at the PDD, the composite image;
identifying, from the composite image, the primary and enhanced image portions of the composite image;
encoding, at the PDD, an encoded stream carrying the enhanced image portion;
transmitting, at the PDD, the encoded stream;
receiving, at the XR device, the encoded stream;
decoding, at the XR device, the encoded stream; and
in accordance with one or more time-synchronized clocks, causing simultaneous display, via the PDD and the XR device, of (i) the primary image portion at the physical display, and (ii) the enhanced image portion at the display of the XR device.

10.-11. (canceled)

12. The method of claim 1, wherein the composite image includes a predetermined boundary, wherein the primary image portion and the enhanced image portion are displayed within the predetermined boundary of the composite image.

13. The method of claim 12, wherein the predetermined boundary of composite image is determined based on any one or more of rendering capability, encoding capability, bandwidth, and network QoS of a host device.

14. (canceled)

15. The method of claim 1, further comprising:
determining a depth of the primary image portion from a current location of the XR device; and
aligning the depth of the enhanced image portion based on the determined depth of the primary image portion such that both the primary image portion and the enhanced image portion are at a same distance as perceived from a current location of the XR device.

16.-17. (canceled)

18. The method of claim 1, further comprising, color-matching the primary image portion with the enhanced image portion, wherein once color is matched, a perception of color and brightness of the content displayed in the primary image portion and the enhanced image portion match within a threshold range.

19.-20. (canceled)

21. A system comprising:
communications circuitry configured to access a physical display device (PDD) and an XR device; and
control circuitry configured to:
identify a content item to be displayed at a physical display associated with the PDD according to a first viewing frustum;
receive a request to provide, at the XR device, a composite image of the content item that spans across a second viewing frustum, wherein the second viewing frustum is larger in size than the first viewing frustum and includes the first viewing frustum;
in response to the receiving of the request to provide the composite image of the content item, the control circuitry configured to:
determine a primary image portion of the composite image to be displayed at the physical display associated with the PDD, the primary image portion spanning a first viewing frustum; and
determine an enhanced image portion of the composite image that corresponds to the primary image portion and that is to be displayed virtually within the second viewing frustum and outside the first viewing frustum, wherein the enhanced image portion maintains image continuity with the primary image portion; and
provide, at a display of the XR device, the composite image including the primary image portion and enhanced image portion of the content item, including:
displaying as a see-through at the display of the XR device, the primary image portion that is displayed on the physical display associated with the PDD, wherein the see-through allows viewing the primary image portion via the display of the XR device; and
generating for display, at the display of the XR device, the enhanced image portion of the composite image such that the displaying of the enhanced image portion is time-synchronized with the display of the primary image portion and such that the enhanced image portion is spatially anchored to the primary image portion.

22. The system of claim 21, wherein the composite image occupies only a portion of the display of the XR device and the display of the XR device allows viewability of an entirety of a field of view (FOV) from the XR device.

23. The system of claim 21, wherein providing, at the display of the XR device, the composite image further comprises, the control circuitry configured to:
generate the composite image;
identify, from the composite image, the primary and enhanced image portions; and
encode a first encoded stream carrying the primary image portion and a second encoded stream carrying the enhanced image portion.

24. The system of claim 23, further comprising, the control circuitry configured to:
transmit, from the server to the PDD, the first and second encoded streams;
receive, at the PDD, the first and second encoded streams; and
at the PDD:
(i) decode the first encoded stream to obtain the primary image portion
(ii) store, at a memory, the primary image portion; and
(iii) transmit, to the XR device, the second encoded stream;
decode, at the XR device, the second encoded stream to obtain the enhanced image portion; and
in accordance with one or more time-synchronized clocks, cause simultaneous display, via the PDD and the XR device, of (i) the primary image portion at the physical display, and (ii) the enhanced image portion at the display of the XR device.

25. (canceled)

26. The system of claim 21, wherein providing, at the display of the XR device, the composite image further comprises, the control circuitry configured to:
generate, at a server, the composite image;
identify, from the composite image, the primary and enhanced image portions;
encode, at the server, a first encoded stream carrying the primary image portion and a second encoded stream carrying the second content portion;
transmit, from the server to a PDD, the first encoded stream;
transmit, from the server to the XR device, the second encoded stream;
at the PDD:
(i) decode the first encoded stream to obtain the primary image portion; and
(ii) store, at a memory, the primary image portion;
decode, at the XR device, the second encoded stream to obtain the enhanced image portion; and
in accordance with one or more time-synchronized clocks, cause simultaneous display, via the PDD and the XR device, of (i) the primary image portion at the physical display, and (ii) the enhanced image portion at the display of the XR device.

27. The system of claim 21, wherein providing, at the display of the XR device, the composite image further comprises, the control circuitry configured to:
generate, at a server, the composite image;
encode, at the server, a given encoded stream carrying the composite image;
transmit, at the server, the given encoded stream;
receive the given encoded stream at a first device, the first device selected from one of the XR device or the PDD;
decode, at the first device, the first encoded stream to obtain the composite image;
identify, from the composite image, the primary and enhanced image portions;
encode, at the first device, a particular encoded stream carrying the primary or enhanced image portion;
transmit, at the first device, the particular encoded stream;
receive the particular encoded stream at a second device, the second device being the one of the XR device or the PDD that was not selected as the first device;
decode, at the second device, the particular encoded stream to obtain the primary or enhanced image portion; and
in accordance with one or more time-synchronized clocks, cause simultaneous display, via the PDD and the XR device, of (i) the primary image portion at the physical display, and (ii) the enhanced image portion at the display of the XR device.

28. The system of claim 21, wherein providing, at the display of the XR device, the composite image further comprises, the control circuitry configured to:
generate, at a server, the composite image;
encode, at the server, a given encoded stream carrying the composite image;
transmit, at the server, the given encoded stream;
receive, at a third device, the given encoded stream;
decode, at the third device, the given encoded stream to obtain the composite image;
identify, from the composite image, the primary and enhanced image portions;
encode, at the third device, a first encoded stream carrying the primary image portion and a second encoded stream carrying the enhanced image portion;
transmit, at the third device, the first and second encoded streams;
receive the first encoded stream at the PDD and the second encoded stream at the XR device;
decode, at the PDD and the XR device, the first and second encoded streams to obtain the primary and enhanced image portions; and
in accordance with one or more time-synchronized clocks, cause simultaneous display, via the PDD and the XR device, of (i) the primary image portion at the physical display, and (ii) the enhanced image portion at the display of the XR device.

29. The system of claim 21, wherein the physical display is communicatively coupled to the PDD and wherein providing, at the display of the XR device, the composite image further comprises, the control circuitry configured to:
generate, at the PDD, the composite image;
identify, from the composite image, the primary and enhanced image portions of the composite image;
encode, at the PDD, an encoded stream carrying the enhanced image portion;
transmit, at the PDD, the encoded stream;
receive, at the XR device, the encoded stream;
decode, at the XR device, the encoded stream; and
in accordance with one or more time-synchronized clocks, cause simultaneous display, via the PDD and the XR device, of (i) the primary image portion at the physical display, and (ii) the enhanced image portion at the display of the XR device.

30.-31. (canceled)

32. The system of claim 21, wherein the composite image includes a predetermined boundary, wherein the primary image portion and the enhanced image portion are displayed by the control circuitry within the predetermined boundary of the composite image.

33. The system of claim 32, wherein the predetermined boundary of composite image is determined by the control circuitry based on any one or more of rendering capability, encoding capability, bandwidth, and network QoS of a host device.

34. (canceled)

35. The system of claim 21, further comprising, the control circuitry configured to:
determine a depth of the primary image portion from a current location of the XR device; and
align the depth of the enhanced image portion based on the determined depth of the primary image portion such that both the primary image portion and the enhanced image portion are at a same distance as perceived from a current location of the XR device.

36.-37. (canceled)

38. The system of claim 21, further comprising, the control circuitry configured to color-match the primary image portion with the enhanced image portion, wherein once color is matched, a perception of color and brightness of the content displayed in the primary image portion and the enhanced image portion match within a threshold range.

39.-40. (canceled)
